(19) United States
(12) Patent Application Publication
(10) Pub. No.: US 2002/0059076 A1
(43) Pub. Date: May 16, 2002

(54) Computer-implemented method for securing intellectual property

(76) Inventors: Jeffry J. Grainger, Portola Valley, CA (US); Stephen K. Boyer, San Jose, CA (US); Cecily Anne Snyder, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/872,764

(22) Filed: Jun. 1, 2001

Related U.S. Application Data
(63) Continuation-in-part of application No. 09/585,947, filed on Jun. 2, 2000.
(60) Provisional application No. 60/253,360, filed on Nov. 27, 2000.

(51) Int. Cl. G06F 17/60

(52) U.S. Cl. 705/1

(57) ABSTRACT

A system and method for facilitating the patent preparation and filing process. The system and method of the present invention may integrate additional functionality such as automated docketing to further facilitate procurement of intellectual property.

Embodiments provide a smart electronic invention disclosure form to be filled out and receives a filled-out invention disclosure in electronic form. The smart disclosure form may actively prompt an inventor to provide information related to best mode, enablement, and inventor identification. The completed smart disclosure form may be converted to a patent application by placing information from pre-selected fields in the invention disclosure form to pre-selected locations in the patent application. The patent application may be filed electronically at the patent office and such filing may trigger automatic calendaring of various reminders and deadlines.

### CROSS-REFERENCES TO RELATED APPLICATIONS

This application is a continuation-in-part of application Ser. No. 09/585,947 filed Jun. 2, 2000, entitled “COMPUTER IMPLEMENTED METHOD FOR SECURING INTELLECTUAL PROPERTY,” by Jeffry J. Grainger. This application is also related to Provisional U.S. application Ser. No. 60/253,360, filed Nov. 27, 2000, entitled “DATA PROCESSING SYSTEM FOR MANAGING INTELLECTUAL PROPERTY,” and listing Jeffry J. Grainger as inventor. The disclosures of 09/585,947 and 60/253,360 are hereby incorporated herein by reference in their entirety.

### BACKGROUND OF THE INVENTION

The present invention relates generally to performing transactions and exchanging information over a wide area network (“WAN”) of computers. More particularly, the present invention relates to computer-implemented method of facilitating the receipt and processing of intellectual property information to prepare intellectual property documents and secure intellectual property rights.

As the world economy becomes more information and technology oriented, patents and other intellectual property are of growing importance. See, eg., KEVIN G. RIVETTE AND DAVID KLINE, REMBRANDTS IN THE ATTIC (2000) and PATRICK H. SULLIVAN, VALUE-DRIVEN INTELLECTUAL CAPITAL: How TO CONVERT INTANGIBLE CORPORATE ASSETS INTO MARKET VALUE (2000). Yet, there are many barriers and pitfalls in the process of procuring patents.

Barriers causing delays in the process from inventor to patent filing include communications barriers between the inventor and the patent attorney or agent, and the need to prepare the written disclosure and prepare formal documentation. Pitfalls in preparing the written disclosure for a U.S. patent application include: the need to properly disclose the best mode contemplated by the inventor of carrying out the invention; the need to provide a disclosure sufficient to enable one of ordinary skill in the pertinent art to make and use the invention; the need to efficiently communicate information between participants in the patent preparation process; and the need to reduce the redundant entry of information.

It is seen from the above that it would be desirable to improve the way in which intellectual property rights are secured. Facilitating the patent preparation and filing process is particularly desirable because of the legal importance of obtaining an early filing date for a patent application.

### SUMMARY OF THE INVENTION

The present invention provides a system and method for facilitating the patent preparation and filing process. The system and method may integrate additional functionality such as automated docketing to further facilitate procurement of intellectual property.

Embodiments of the present invention provide a smart electronic invention disclosure form to be filled out by the inventor and then the filled-out invention disclosure is transmitted in electronic form to a person designated to review the invention disclosure. An electronic file is created using information from the invention disclosure either when the disclosure is started by a user (e.g., inventor) or when it is submitted for consideration. The smart disclosure form may actively prompt an inventor to provide information related to best mode, enablement, and inventor identification. The completed smart disclosure form may be converted to a patent application or defensive (or technical) publication by placing information from pre-selected fields in the invention disclosure form to pre-selected locations in the patent application, or defensive publication, template. The patent application, or defensive publication, may be submitted electronically to the appropriate agency, e.g., the patent office or publisher, and such submission may trigger automatic calendaring of various reminders and deadlines.

In one embodiment, the present invention also provides a computer-implemented method of processing first invention disclosure data, the method comprising: prompting a user on a client system for first invention disclosure data, receiving the first invention disclosure data from the client system on a server system, wherein the first invention disclosure data comprises a plurality of invention data elements, storing the first invention disclosure data on the server system, and processing each of the plurality of invention data elements using a corresponding plurality of invention analysis tools to produce a plurality of invention analysis results.

In another embodiment, the present invention provides a computer-implemented method of processing one or more invention disclosures into a defensive publication. The process comprises prompting a user on a client system for first invention disclosure data, receiving the first invention disclosure data from the client system on a server system, storing the first invention disclosure data on the server system, and processing each of the plurality of-invention data elements using a corresponding plurality of invention analysis tools to produce a plurality of invention analysis results.

In another embodiment, the present invention provides server system comprising a processor and a computer-readable memory coupled to said processor, said computer-readable memory including computer instructions that generate web pages to guide a client system through a process to create invention disclosure data, store the invention disclosure data in a database, and upon receipt of a command from a client system, automatically generate a provisional patent application from said invention disclosure data. In another embodiment, the computer instructions generate the provisional patent application when the command has a first value, and the computer instructions generate a non-provisional application when the command has a second value.

Other objects, features, and advantages of the present invention will become apparent upon consideration of the following detailed description and the accompanying drawings.

### BRIEF DESCRIPTION OF THE DRAWINGS

FIG. 1A is a simplified block diagram of a system 100 according to a first embodiment of the present invention having a smart filing server and an automated docketing server.

FIG. 1B is a simplified block diagram of a system 120 according to a second embodiment of the present invention having an intellectual property server.

FIG. 1C is a simplified block diagram of a system 130 according to a third embodiment of the present invention having an automated docketing server connected to the network via the Internet and a smart filing server connected to a network.

FIG. 1D is a simplified block diagram of a system 140 according to a fourth embodiment of the present invention having a smart filing server connected to the network via the Internet and an automatic docketing server connected to a network.

FIG. 1E is a simplified block diagram of a system 150 according to a fifth embodiment of the present invention having and automated docketing server and smart filing server connected to a network.

FIG. 1F is a simplified block diagram of a system 160 according to a sixth embodiment of the present invention having an intellectual property server connected to a network.

FIG. 2 is a simplified block diagram of a computer system 200 in accordance with an embodiment of the present invention illustrating the major components of the system.

FIG. 3A is a simplified block diagram of a smart filing server 300 in accordance with an embodiment of the present invention.

FIG. 3B is a simplified block diagram of an automated docketing server 330 in accordance with an embodiment of the present invention.

FIG. 3C is a simplified block diagram of an intellectual property server 340 in accordance with an embodiment of the present invention.

FIG. 4 is a flow chart depicting a method 400 for generating an invention disclosure in accordance with an embodiment of the present invention.

FIG. 5A is a flow chart depicting a method 500 for automated filing of a patent application in a patent office in accordance with an embodiment of the present invention.

FIG. 5B is a flow chart depicting a method 550 for automated submission of a defensive publication to a publisher in accordance with an embodiment of the present invention.

FIG. 6 is a flow chart depicting a method 600 for automatic calendaring subsequent to the filing of a patent application in accordance with an embodiment of the present invention.

FIG. 7 is a simplified block diagram showing the relationship between an intellectual property data processing system 100 according to one embodiment of the present invention and participants in the patent process.

FIGS. 8A-8M are example web pages generated by an IP data processing system to process invention disclosure data according to one embodiment of the present invention.

FIG. 9 illustrates a computer-implemented method of processing disclosure data according to one embodiment of the present invention.

FIG. 10 illustrates a computer-implemented method of processing disclosure data according to another embodiment of the present invention.

FIG. 11 illustrates a computer-implemented method of processing disclosure data according to another embodiment of the present invention.

FIG. 12 illustrates how a plurality of different data fields of the invention disclosure data may be processed by a corresponding plurality of invention disclosure analysis tools according to one embodiment of the present invention.

FIG. 13 illustrates how multiple invention disclosure data from multiple users and from multiple versions of a single user may be processed by invention disclosure analysis tools according to one embodiment of the present invention.

### DESCRIPTION OF THE SPECIFIC EMBODIMENTS

The present invention provides a data processing system and a computer-implemented method of facilitating the preparation of intellectual property documents, such as patent applications, securing intellectual property rights and managing intellectual property (“IP”) assets, including, for example, pending patent applications and issued or granted patents. For convenience, the invention is described below primarily with respect to filing, prosecuting and managing patent applications. It is to be understood, however, that the present invention is useful for managing other forms of intellectual property including, but not limited to, trademarks, technical or defensive publications, and copyrights.

The present invention provides a data processing system and a computer implemented method of facilitating the preparation of intellectual property documents.

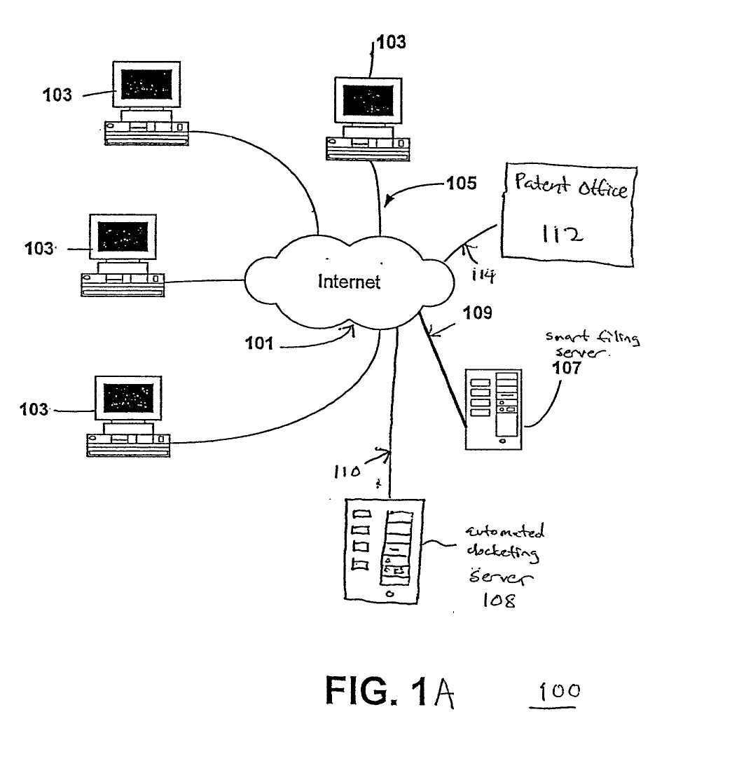

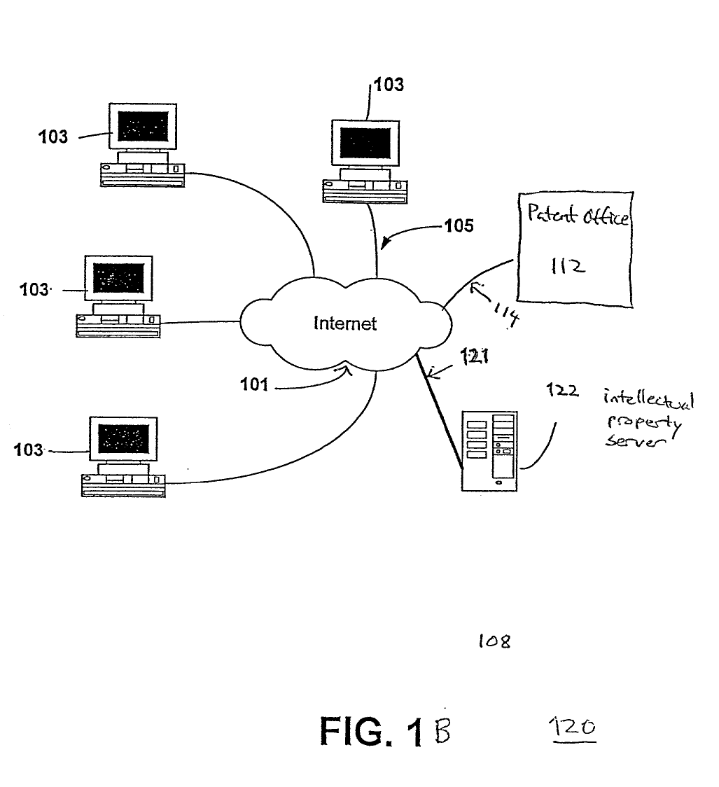

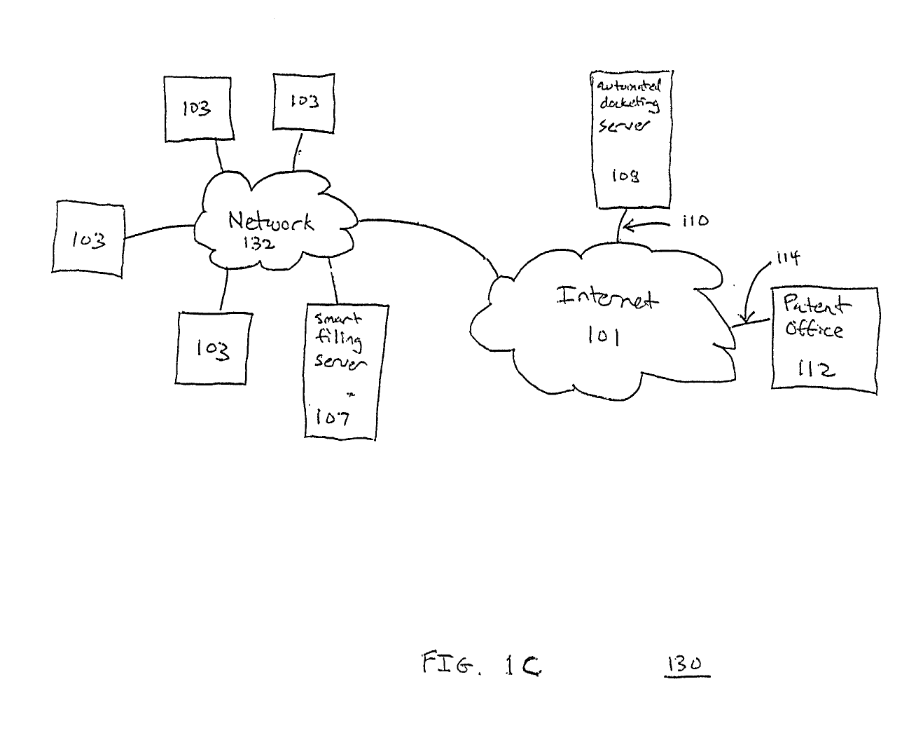

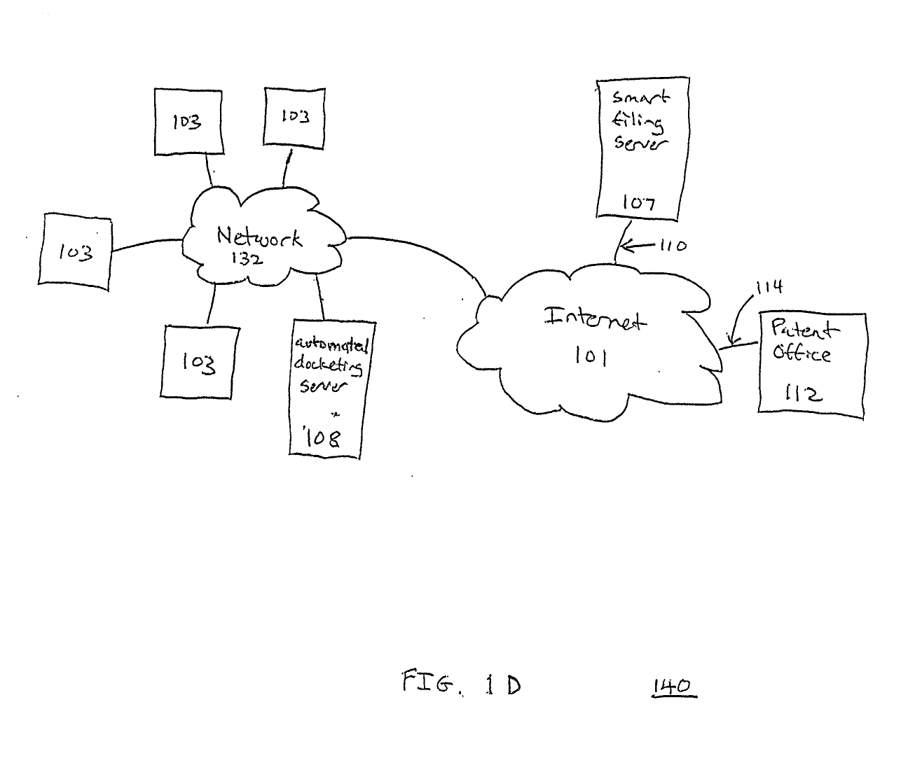

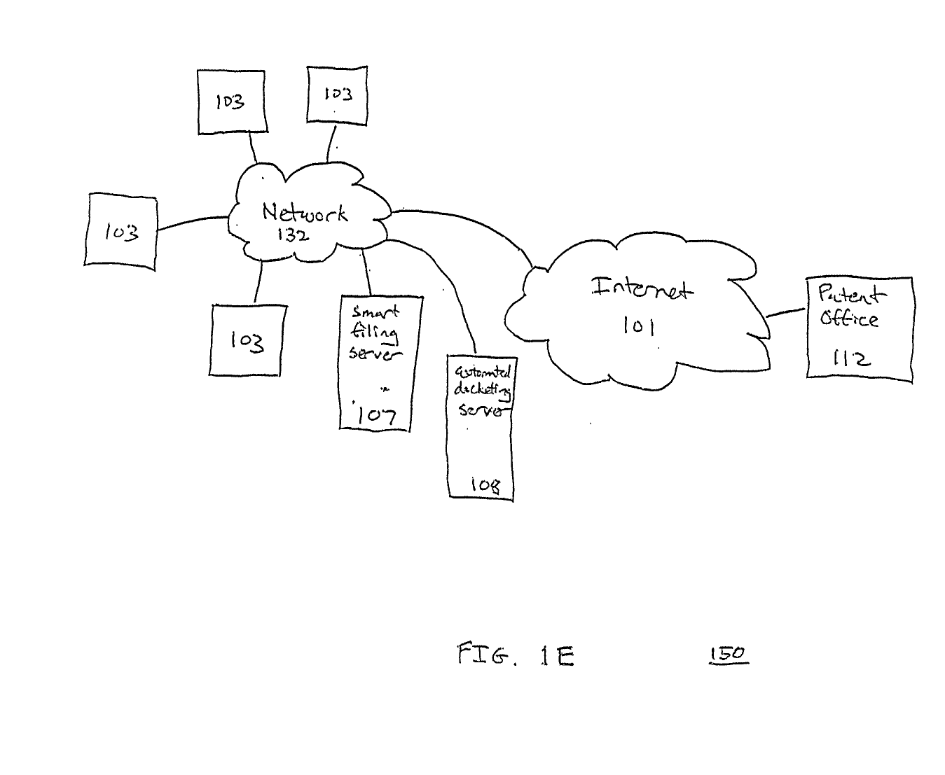

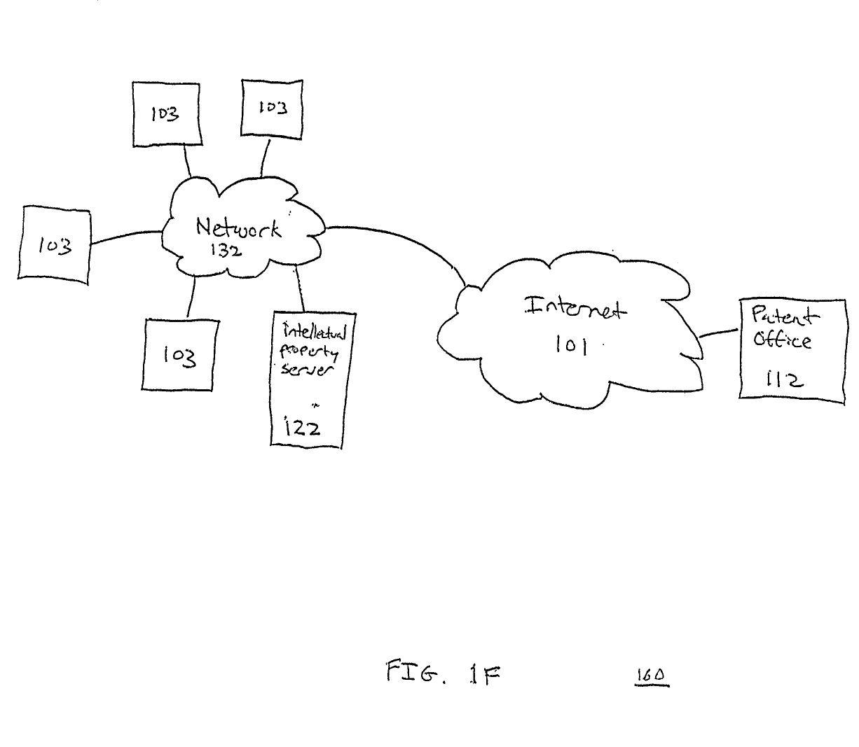

FIG. 1A is a simplified block diagram of a system 100 according to a first embodiment of the present invention. This diagram is merely an illustration and should not limit the scope of the claims herein. One of ordinary skill in the art would recognize other variations, modifications, and alternatives.

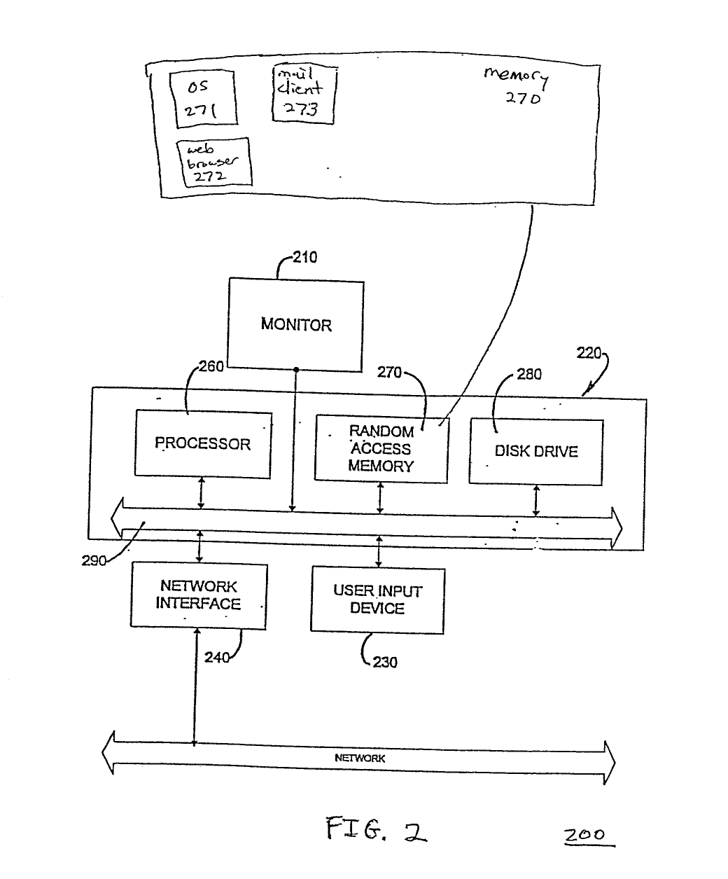

Among other features, the system 100 couples to a wide area network (“WAN”) of computers such as, for example, the Internet. The network of computers includes workstations or computer terminals 103, which can be IBM compatible personal computers (“PCs”), workstations, network computers (“NCs”), remote computing devices, television sets, or other computer-like devices. These computers are coupled through lines 105 to the Internet 101, which includes a variety of servers and other computers. An example of an implementation 200 of a computer 103 in accordance with an embodiment of the present invention is described below in relation with FIG. 2.

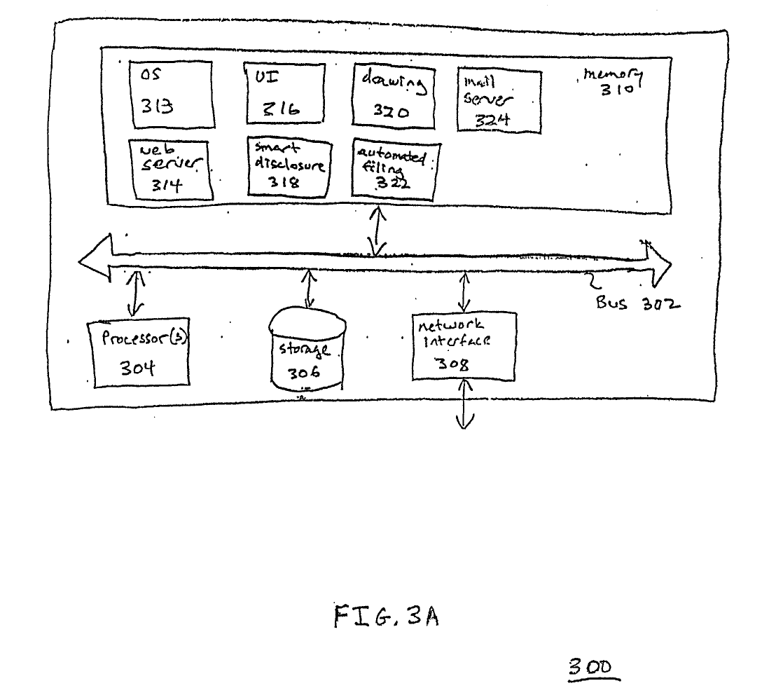

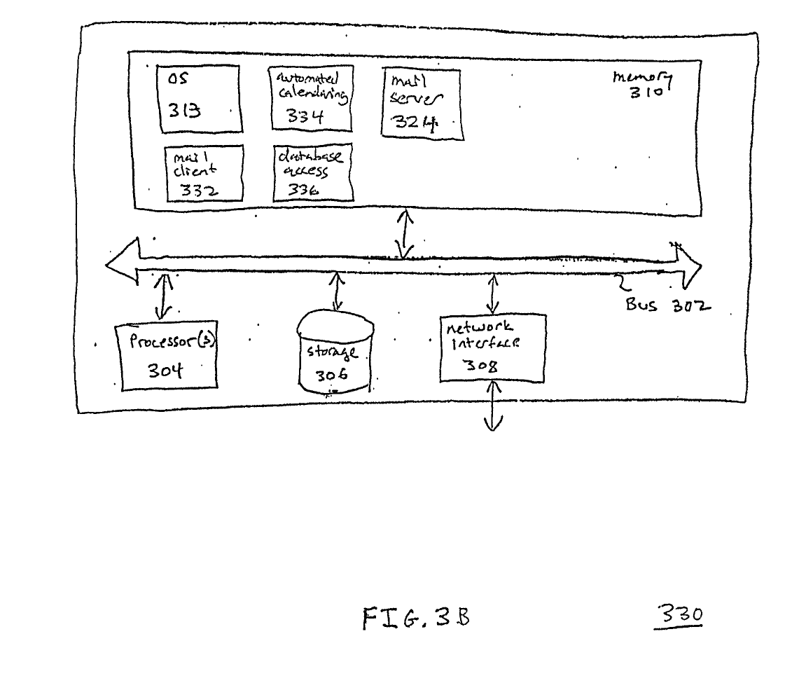

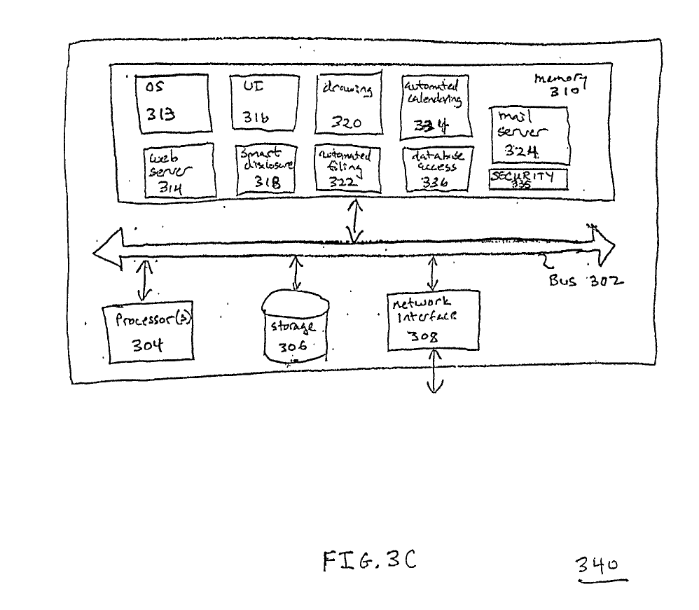

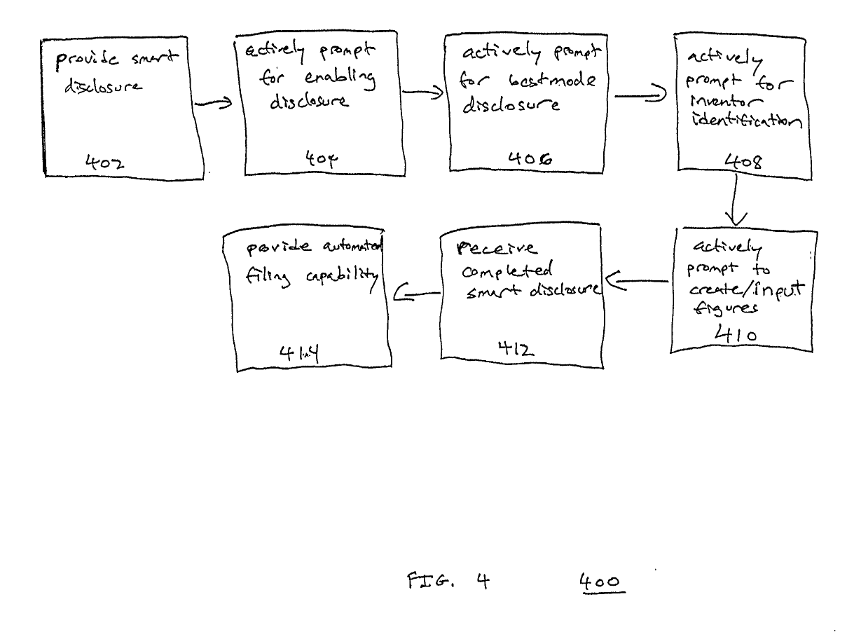

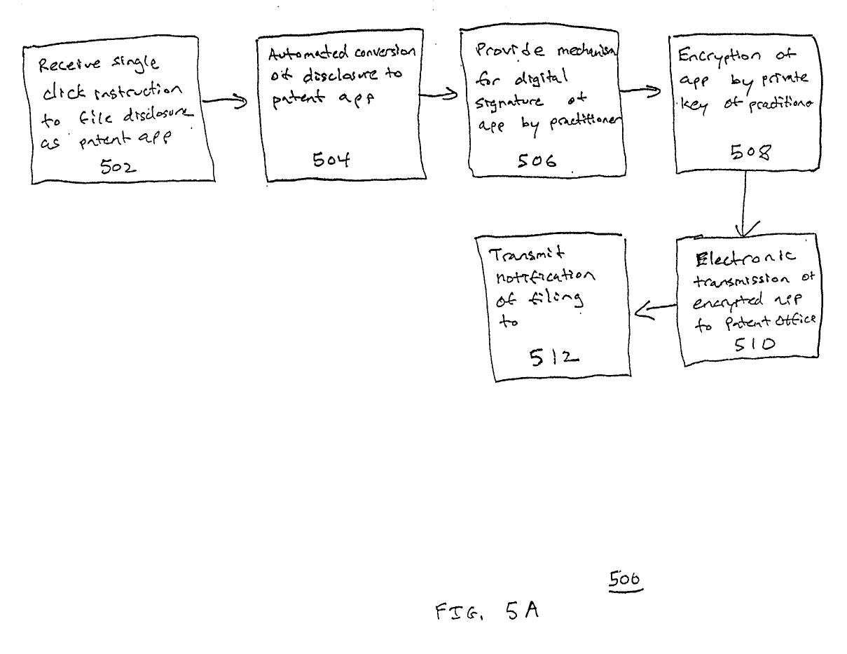

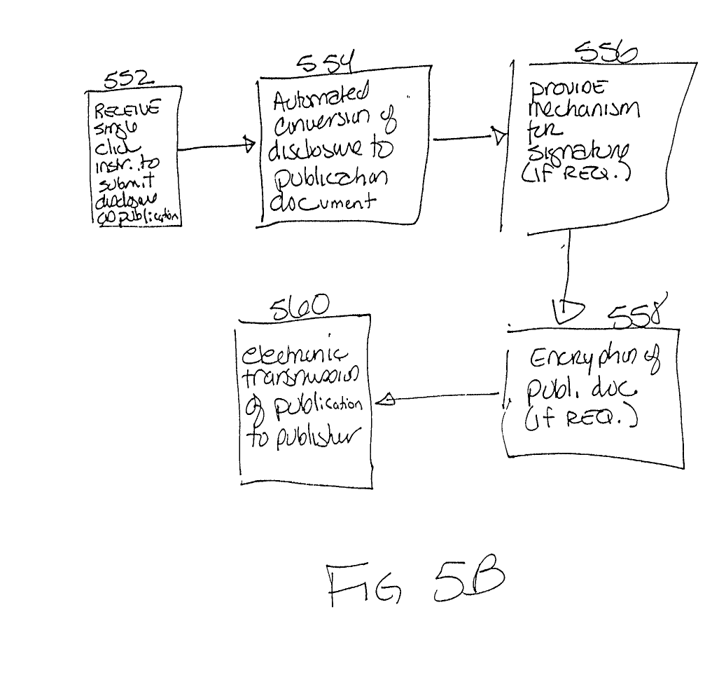

A first server shown is a smart filing server 107. Smart filing server 107 may be coupled to the Internet 101 through line 109, which can be through an internet service provider, which is commonly known as an ISP. An example of an implementation 300 of a smart filing server 107 in accordance with an embodiment of the present invention is described below in relation to FIG. 3A. However, smart filing server 107 may be implemented with any suitable server for providing the smart filing services as described below in relation with the flowcharts of FIGS. 4 and 5.

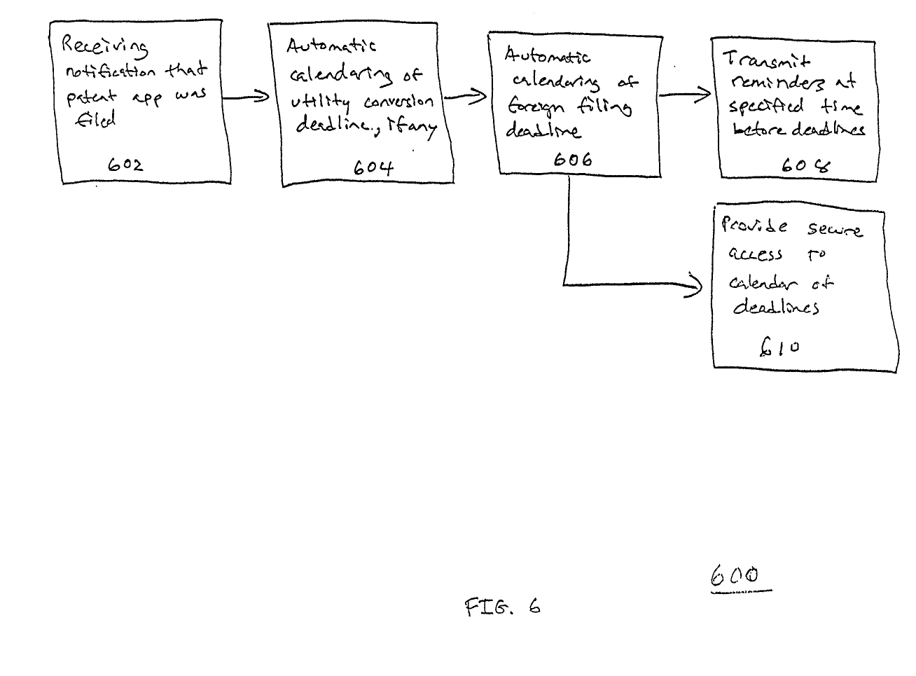

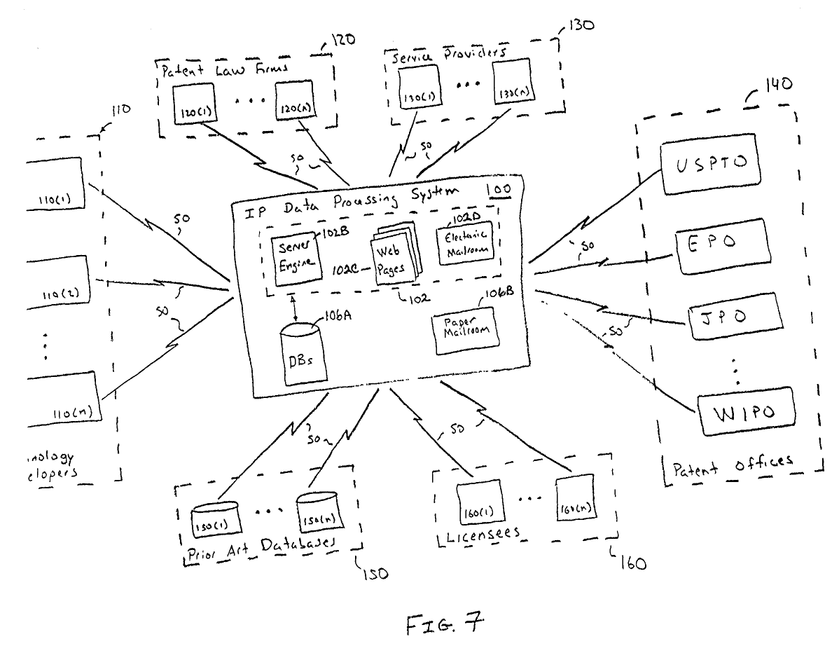

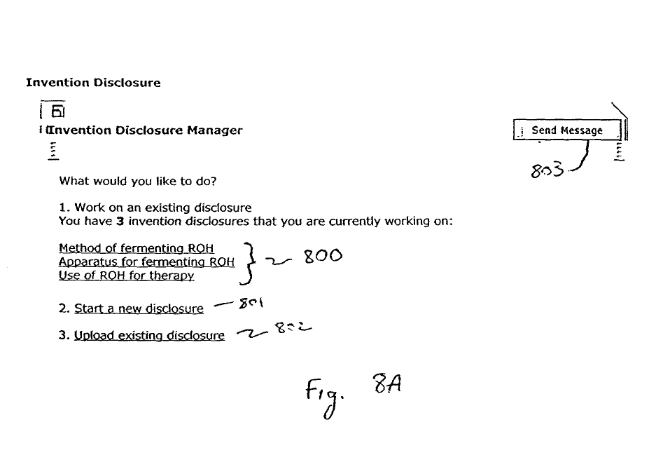

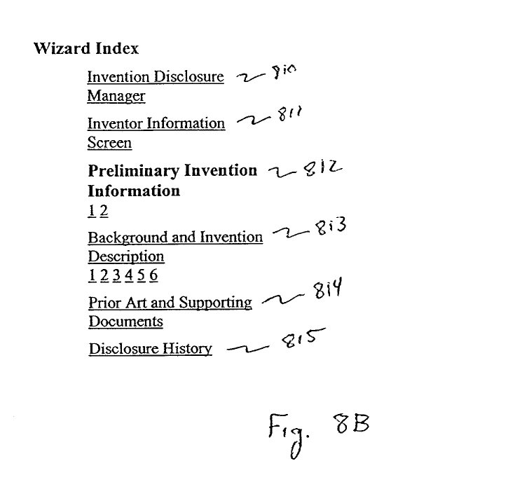

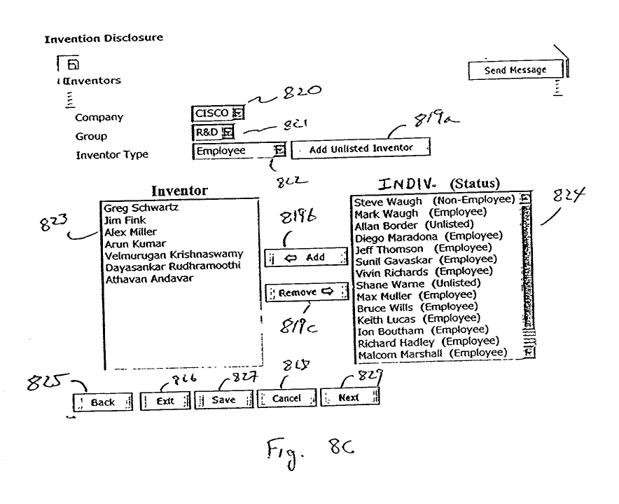

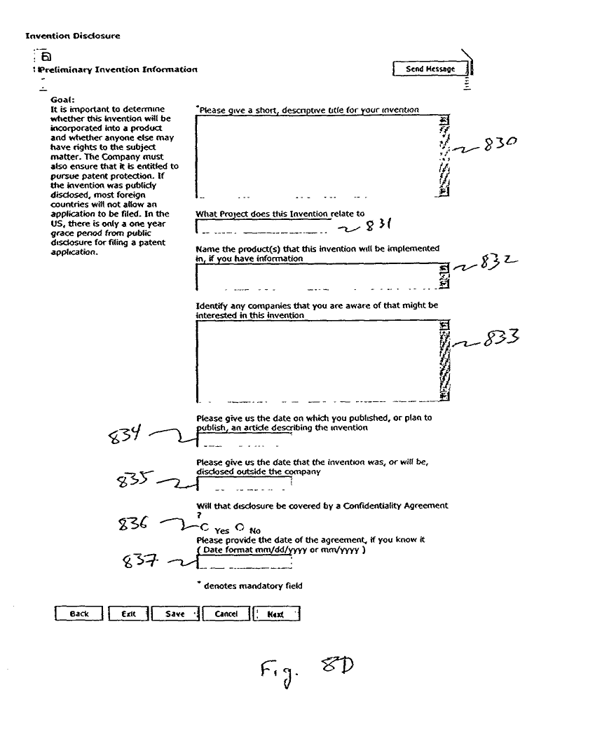

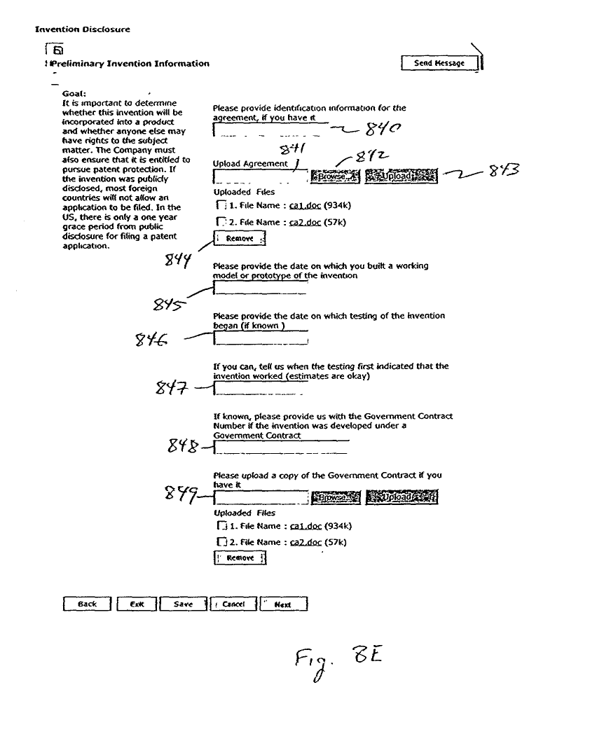

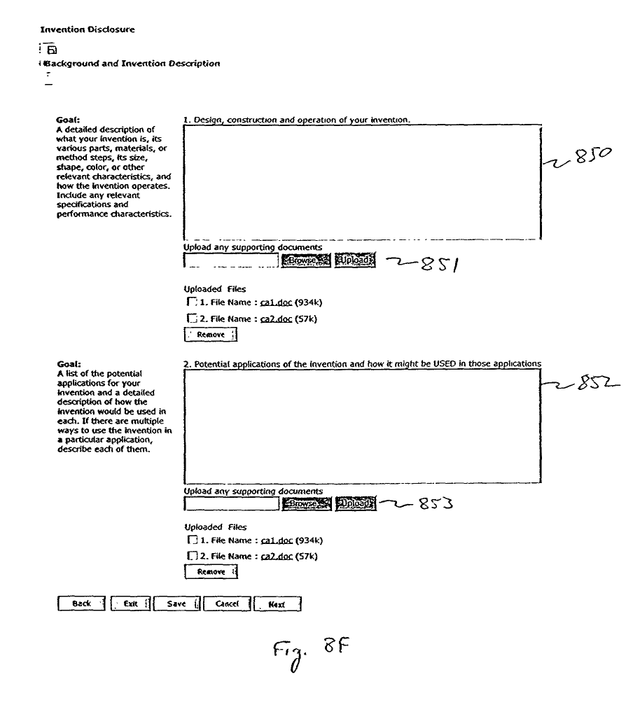

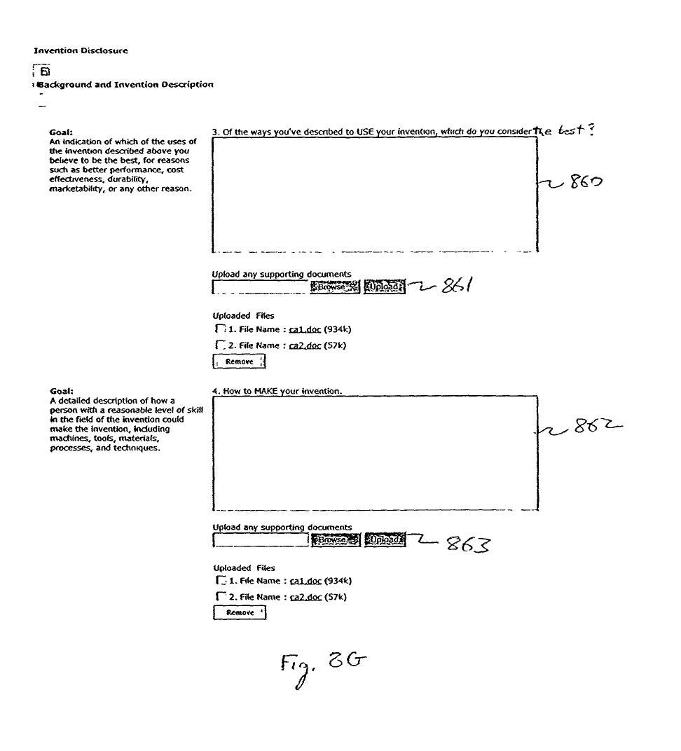

A second server shown is an automated docketing server 108. Automated docketing server 108 may be coupled to the Internet 101 through line 110, which can be through an ISP. An example of an implementation 330 of an automated docketing server 108 in accordance with an embodiment of the present invention is described below in relation to FIG. 3B. However, as will be appreciated by those of skill in the art, automated docketing server 108 may be implemented with any suitable server for providing the automated docketing services as described below in relation to the flowchart of FIG. 6. Further description of automated docketing servers and services is contained in the related application entitled “Computer-Implemented Method of Docketing Intellectual Property Filings,” inventor Jeffry J. Grainger, filed Jun. 2, 2000, and identified as Ser. No. 09/585,989

FIG. 1B is a simplified block diagram of a system 120 according to a second embodiment of the present invention. This diagram is merely an illustration and should not limit the scope of the claims herein. One of ordinary skill in the art would recognize other variations, modifications, and alternatives.

In the second embodiment, the functionality of the smart filing 107 and automated docketing 108 servers are combined in a single IP server 122 coupled to the Internet 101. IP server 122 may be coupled to the Internet 101 through line 121, which can be through an ISP. An example of an implementation 340 of an IP server 122 in accordance with an embodiment of the present invention is described below in relation to FIG. 3C. However, IP server 122 may be implemented with any suitable server for providing the smart filing and automated docketing services as described below in relation to the flowcharts of FIG. 4-6.

FIG. 1C is a simplified block diagram of a system 130 according to a third embodiment of the present invention. This diagram is merely an illustration and should not limit the scope of the claims herein. One of ordinary skill in the art would recognize other variations, modifications, and alternatives.

In the third embodiment, computers 103 and smart filing server 107 are networked together via a private network 132. The private network 132 is coupled to the Internet 101, for example, via a router. The Internet 101 interconnects the private network 132 to a patent office 112 and to an automated docketing server 108. This embodiment provides greater privacy and security for functions of the smart filing server 107.

FIG. 1D is a simplified block diagram of a system 140 according to a fourth embodiment of the present invention. This diagram is merely an illustration and should not limit the scope of the claims herein. One of ordinary skill in the art would recognize other variations, modifications, and alternatives.

In the fourth embodiment, computers 103 and automated docketing server 108 are networked together via a private network 132. The private network 132 is coupled to the Internet 101, for example, via a router. The Internet 101 interconnects the private network 132 to a patent office 112 and to a smart filing server 107. This embodiment provides greater privacy and security for functions of the automated docketing server 108.

FIG. 1E is a simplified block diagram of a system 150 according to a fifth embodiment of the present invention. This diagram is merely an illustration and should not limit the scope of the claims herein. One of ordinary skill in the art would recognize other variations, modifications, and alternatives.

In the fifth embodiment, computers 103, smart filing server 107, and automated docketing server 108 are all networked together via a private network 132. The private network 132 is coupled to the Internet 101, for example, via a router. The Internet 101 interconnects the private network 132 to a patent office 112. This embodiment provides greater privacy and security for functions of both the smart filing 107 and automated docketing 108 servers.

FIG. 1F is a simplified block diagram of a system 160 according to a sixth embodiment of the present invention. This diagram is merely an illustration and should not limit the scope of the claims herein. One of ordinary skill in the art would recognize other variations, modifications, and alternatives.

In the sixth embodiment, computers 103 and IP server 122 are networked together via a private network 132. The private network 132 is coupled to the Internet 101, for example, via a router. The Internet 101 interconnects the private network 132 to a patent office 112. This embodiment provides greater privacy and security for functions of the IP server 122.

FIG. 2 is a simplified block diagram of a computer system 200 according to an embodiment of the present invention. This diagram is merely an illustration and should not limit the scope of the claims herein. The system 200 includes a monitor 210, a computing system 220, a user input device 230, and a network interface 240.

Computer system 220 preferably includes familiar components such as a processor 260, and memory storage devices 270, such as a random access memory (“RAM”), a fixed disk drive 280, and a system bus 290 interconnecting the above components.

In a preferred embodiment, computer system 220 includes a recent Pentium® microprocessor from Intel Corporation of Santa Clara, Calif. and runs a recent Windows® operating system from Microsoft Corporation of Redmond, Washington. The embodiment typically includes a web browser program such as Microsoft Internet Explorer or Netscape Navigator. Many other systems, such as MacOS™ from Apple Corporation, running upon G3 based microprocessors, or Solaris® from Sun Microsystems or UNIX running upon a SPARC station, and the like can also be used.

Memory (e.g., RAM) 270 and fixed disk drive 280 are mere examples of tangible media for storage of computer programs, e-mail messages, audio and/or video data, and code implementing embodiments of the present invention. Other types of tangible media include SRAM, floppy disks, optical storage media such as CD-ROMs and bar codes, semiconductor memories such as flash memories, read-only-memories (“ROMs”), application specific integrated circuits (“ASICs”), battery-backed volatile memories, and the like.

Preferably, memory 270 includes various software devices, such as an operating system (“O/S”) 271 and a web browser application 272. The O/S 271 may comprise, for example, a recent Windows® operating system from Microsoft Corporation, or a MacOS™ from Apple Computer, or a version of the UNIX operating system, such as Solaris® from Sun Microsystems or Linux®. The web browser application 272 preferably uses hypertext transfer protocol (“http”) to communicate over the Internet 101 with web servers. The web browser 272 may comprise, for example, a version of the Navigator software from Netscape Communications or the Internet Explorer software from Microsoft Corporation. The mail client 273 may comprise, for example, a version of the Outlook® software from Microsoft Corporation, or the GroupWise® software from Novell, Inc.

User input device 230 may include a mouse, a trackball, a keyboard, a keypad, a touch pad, a joystick, a digitizing tablet, a wireless controller, a microphone, or other suitable input devices, or combinations thereof.

Network interface 240 may be any type of interface to a computer network. For example network interface 240 may be a modem, an Ethernet or fast Ethernet interface, a LocalTalk connection, or the like. As disclosed above, the computer network may be any type of network such as the Internet, an Intranet, an IPX network, private tunnel, local area network (“LAN”), WAN, and the like. The network interface also can be a modem.

FIG. 3A is a simplified block diagram of a smart filing server 300 according to the first embodiment of the present invention. This diagram is merely an illustration and should not limit the scope of the claims herein. One of ordinary skill in the art would recognize other variations, modifications, and alternatives.

The smart filing server 300 preferably includes familiar components such as system bus 302, processor or processors 304, storage device 306, network interface 308, and memory 310. In addition, the smart filing server 300 may include input devices (such as a keyboard and mouse) for use by a system administrator in running and maintaining the smart filing server 300. The smart filing server 300 couples to the Internet 101 via the network interface 308 and a router (or similar device) 312.

The system bus 302 interconnects the processor(s) 304, the storage device 306, the network interface 308, and the memory 310. The processor(s) may comprise, for example, a recent Pentium® microprocessor from Intel Corporation. The storage device 306 may comprise, for example, a disk drive for storage of computer programs and code implementing embodiments of the present invention. Alternatively, the storage device 306 may comprise an array of disks or a storage area network. The network interface 308 may comprise, for example, an interface to a router 312 or similar device that couples to the Internet 101.

The memory 310 may comprise, for example, RAM. As discussed above, RAM (like disk drives and other storage and memory devices) is an example of a tangible media for storage of computer program devices and data. Like the storage device 306, the memory 310 may be used to hold computer programs and code implementing embodiments of the present invention. The memory 310 is typically more quickly accessible by the processor 304 than the storage device 306 is.

Preferably, the memory 310 includes various software devices, such as an O/S 313, a web server application 314; a user interface (“UI”) module 316, a smart disclosure module 318, a drawing module 320, an automated filing module 322, and a mail server 324. Other modules may also be included for additional functionalities. For example, a search module may be included to provide capability to a user to search for information such as prior art documents (patents, articles, etc.). As another example, a mapping module may be included to provide capability to a user to visually map the invention in relation to related patents.

The operating system 313 may comprise, for example, a recent Windows® operating system from Microsoft Corporation, or a MacOS™ from Apple Computer, or a version of the UNIX operating system, such as Solaris® from Sun Microsystems or Linux®.

The web server application 314 uses http to communicate over the Internet 101 with web browsers on client computers 103. The web server 314 may comprise, for example, a version of the Apache web server, or web server software from Microsoft or Netscape.

The UI module 316 provides an interface between a user of a client computer 103 and the functions of other software modules in the memory 310. For example, interaction between a user and the smart disclosure module 318 occurs via the UI module 316. As another example, user access to the capabilities of the drawing module 320 occurs via the UI module 316. Preferably, the user interface module 316 is implemented using an object oriented design to allow the UI to be changed quickly and easily.

The smart disclosure module 318 provides functionality for a technique to facilitate generation of an invention disclosure. This technique is described in further detail below in relation to FIG. 4. The drawing module 320 provides capabilities to create or scan figures as described below in relation to block 410 of FIG. 4.

The automated filing module 322 provides functionality for a technique to facilitate submitting an application to a patent office or a defensive publication to a publisher. This technique is described below in relation to FIG. 5.

The mail server 324 provides functionality to send electronic mail. The mail server 324 in the smart filing server 300 of FIG. 3A may be utilized, for example, to communicate with a mail client 332 in the automatic docketing server 330 of FIG. 3B.

FIG. 3B is a simplified block diagram of an automated docketing server 330 according to the first embodiment of the present invention. This diagram is merely an illustration and should not limit the scope of the claims herein. One of ordinary skill in the art would recognize other variations, modifications, and alternatives.

The automated docketing server 330 preferably includes familiar components such as system bus 302, processor or processors 304, storage device 306, network interface 308, and memory 310. In addition, the automatic docketing server 330 may include input devices (such as a keyboard and mouse) for use by a system administrator in running and maintaining the automatic docketing server 330. The automatic docketing server 330 couples to the Internet 101 via the network interface 308 and a router (or similar device) 312.

The system bus 302 interconnects the processor(s) 304, the storage device 306, the network interface 308, and the memory 310. The processor(s) may comprise, for example, a recent Pentium® microprocessor from Intel Corporation. The storage device 306 may comprise, for example, a disk drive for storage of computer programs and code implementing embodiments of the present invention. Alternatively, the storage device 306 may comprise an array of disks or a storage area network. The network interface 308 may comprise, for example, an interface to a router 312 or similar device that couples to the Internet 101.

The memory 310 may comprise, for example, RAM. As discussed above, RAM (like disk drives and other storage and memory devices) is an example of a tangible media for storage of computer program devices and data. Like the storage device 306, the memory 310 may be used to hold computer programs and code implementing embodiments of the present invention. The memory 310 is typically more quickly accessible by the processor 304 than the storage device 306 is and therefore may be a more desirable media for storing computer programs.

Preferably, the memory 310 includes various software devices, such as an O/S 313; a mail server 324, a mail client 332, an automatic calendaring module 334; and a database access module 336. Other modules may also be included, such as a web server module 314, a UI module 316, and a security module 335 to enable secure web access by a user to information and functions of the automated docketing server 330 as described below in relation to block 610 of FIG. 6.

The operating system 313 may comprise, for example, a recent Windows® operating system from Microsoft Corporation, or a MacOS™ from Apple Computer, or a version of the UNIX operating system, such as Solaris® from Sun Microsystems or Linux®.

The mail server 324 provides functionality to send electronic mail. The mail server 324 in the automatic docketing server 330 of FIG. 3B may be utilized, for example, to transmit docketing reminders to users as described below in relation to block 608 of FIG. 6.

The mail client 332 provides functionality to receive electronic mail. The mail client 332 in the automatic docketing server 330 of FIG. 3B may be utilized, for example, to communicate with the mail server 324 in the smart filing server 300 of FIG. 3A.

The automatic calendaring module 334 provides functionality for a technique to facilitate calendaring of deadlines and reminders relating to patent filings. This technique is described below in relation to FIG. 6.

The database access module 336 provides capabilities to store and retrieve calendaring related information from a database system. The database system may utilize the storage system 306 of the automatic docketing server 330 and/or may utilize a storage array coupled to the automatic docketing server 330.

Further description of automated calendaring is contained in the related application entitled “Computer-Implemented Method of Docketing Intellectual Property Filings,” inventor Jeffry J. Grainger, described and incorporated supra

FIG. 3C is a simplified block diagram of an intellectual property server 340 according to the second embodiment of the present invention. This diagram is merely an illustration and should not limit the scope of the claims herein. One of ordinary skill in the art would recognize other variations, modifications, and alternatives.

The intellectual property server 340 preferably includes familiar components such as system bus 302, processor or processors 304, storage device 306, network interface 308, and memory 310. In addition, the intellectual property server 340 may include input devices (such as a keyboard and mouse) for use by a system administrator in running and maintaining the intellectual property server 340. The intellectual property server 340 couples to the Internet 101 via the network interface 308 and a router (or similar device) 312.

The system bus 302 interconnects the processor(s) 304, the storage device 306, the network interface 308, and the memory 310. The processor(s) may comprise, for example, a recent Pentium® microprocessor from Intel Corporation. The storage device 306 may comprise, for example, a disk drive for storage of computer programs and code implementing embodiments of the present invention. Alternatively, the storage device 306 may comprise an array of disks or a storage area network. The network interface 308 may comprise, for example, an interface to a router 312 or similar device that couples to the Internet 101.

The memory 310 may comprise, for example, RAM. As discussed above, RAM (like disk drives and other storage and memory devices) is an example of a tangible media for storage of computer program devices and data. Like the storage device 306, the memory 310 may be used to hold computer programs and code implementing embodiments of the present invention. The memory 310 is typically more quickly accessible by the processor 304 than the storage device 306 is and therefore may be a more desirable media for storing computer programs.

Preferably, the memory 310 includes various software devices, such as an O/S 313, a web server application 314; a UI module 316, a smart disclosure module 318, a drawing module 320, an automated filing module 322, a mail server 324, an automatic calendaring module 334, and a database access module 336. Other modules may be included for additional functionality.

The O/S 313 may comprise, for example, a recent Windows® operating system from Microsoft Corporation, or a MacOS™ from Apple Computer, or a version of the UNIX® operating system, such as Solaris® from Sun Microsystems or Linux®.

The web server application 314 uses http to communicate over the Internet 101 with web browsers on client computers 103. The web server 314 may comprise, for example, a version of the Apache web server, or web server software from Microsoft or Netscape.

The UI module 316 provides an interface between a user of a client computer 103 and the functions of other software modules in memory 310. For example, interaction between a user and the smart disclosure module 318 occurs via the UI module 316. As another example, user access to the capabilities of the drawing module 320 occurs via the UI module 316. Preferably, the UI module 316 is implemented using an object oriented design to allow the UI to be changed quickly and easily.

The smart disclosure module 318 provides functionality for a technique to facilitate generation of an invention disclosure. This technique is described below in relation to FIG. 4. The drawing module 320 provides capabilities to create or scan figures as described below in relation to block 410 of FIG. 4.

The automated filing module 322 provides functionality for a technique to facilitate filing of a patent application at a patent office. This technique is described below in relation to FIG. 5.

The mail server 324 provides functionality to send electronic mail. The mail server 324 in the intellectual property server 340 of FIG. 3C may be utilized, for example, to transmit docketing reminders to users as described below in relation to block 608 of FIG. 6.

The automatic calendaring module 334 provides functionality for a technique to facilitate calendaring of deadlines and reminders relating to patent filings. This technique is described below in relation to FIG. 6.

The database access module 336 provides capabilities to store and retrieve calendaring related information from a database system. The database system may utilize the storage system 306 of the automatic docketing server 330 and/or may utilize a storage array coupled to the automatic docketing server 330.

FIG. 4 is a flow chart depicting a method 400 for generating an invention disclosure in accordance with an embodiment of the present invention. The flow chart includes seven steps. This flow chart is merely an illustration and should not limit the scope of the claims herein. One of ordinary skill in the art would recognize other variations, modifications, and alternatives.

In a first step 402, an interactive smart disclosure form is provided to an inventor (user). The interactive form may be supplied by the smart disclosure module 318 in either a smart filing server 107 or an integrated IP server 122. The smart disclosure module 318 may utilize the UI module 316 in providing the interactive form.

The interactive form may include a plurality of pre-selected fields for information to be input. Such information may be later utilized to create a patent application by selectively placement of the information in pre-selected locations in the patent application.

In a second step 404, the interactive form actively prompts the inventor to provide a disclosure in sufficient details so as to enable a person skilled in the relevant art to make and use the invention. The interactive form also gives examples of enabling details.

In a third step 406, the interactive form actively prompts the inventor to provide best modes contemplated by the inventor of carrying out the invention. The interactive form also gives examples of best modes for inventions.

In a fourth step 408, the interactive form actively prompts the inventor using the form to identify each and every inventor of the invention, including himself/herself and any co-inventors. The interactive form may also inform the inventor using the form as to the appropriate legal standard of inventorship.

In a fifth step 410, the interactive form actively prompts the inventor to create or input drawings to illustrate the invention. Creation of drawings is facilitated by providing access to a drawing module 320. The drawing module 320 provides drawing tools for the inventor to create the illustrative drawings for the patent application. Input of already created drawings is facilitated by providing a scanner or other tool to scan drawings into the system.

In a sixth step 412, the completed form is received. The completed form may or may not include formal patent claims. Artificial intelligence (“AI”) procedures may be used to analyze the completed form to determine if the inventor should be prompted for additional disclosure. For example, if no drawings have been provided but the completed form includes method claims, then AI algorithm may suggest to the inventor that flow charts be created to support the method claims.

In a seventh step 414, an automated submission capability is provided to convert the completed form into either a patent application or a technical publication. Depending upon which submission capability is chosen, affects the operation of the automated submission capability. For example, where a patent application is to be filed, the system can further determine that, for example, if the completed form does not include patent claims, then the patent application is a United States provisional application.

Conversion of the completed form to a patent application may include the step of placing information from pre-selected fields in one or more related invention disclosure forms into pre-selected locations in the patent application template or technical publication template.

The automated filing capability may be provided by an automated filing module 322 in either a smart filing server 107 or an integrated IP server 122. An embodiment of the automated filing capability is described in further detail below in relation to FIGS. 5A and 5B.

Additional steps may also be included in the smart disclosure process. For example, a step may be included where one or more databases or other resources (such as the Internet) are searched using keywords from the disclosure. This step may provide useful prior art to the attention of the user. As another example, a step may be included where the invention may be mapped within a landscape of the search results. As yet another example, a step may be included where the search results are used to create an information disclosure citation list for filing at a patent office.

FIG. 5A is a flow chart depicting a method 500 for automated submission of a patent application at a patent office in accordance with an embodiment of the present invention. The flow chart includes six steps. This flow chart is merely an illustration and should not limit the scope of the claims herein. One of ordinary skill in the art would recognize other variations, modifications, and alternatives.

In a first step 502, a single click instruction is received from the inventor. Such a single click may involve, for example, a press of a mouse button on an icon which indicates that the disclosure form is complete and ready for filing as a patent application at a patent office. The single click instruction is received by the automated filing module 322. Alternatively, a verification step may be included in order to verify that the disclosure form is indeed ready for filing.

In a second step 504, the automated submission module 322 performs an automated conversion of the completed disclosure form into a format of a patent application. The automated conversion utilizes information input by the user into various fields of the smart disclosure form and puts the information into the selected format of a patent application.

For example, such a format may include: a cover page with title, inventors, and assignee; a background; a summary; a brief description of the drawings; a detailed description; claims (if any); abstract; and drawings. In addition, the format may also include other documents (for example, transmittal, postcard, declaration, power of attorney, and small entity statement) for filing by express mail or electronically. Other appropriate formats would be known by those of skill in the art and not presented in order to avoid obscuring the invention.

In a third step 506, the automated submission module 322 may provide a mechanism for the patent application to be executed by an inventor, applicant, or a registered patent practitioner. Such a mechanism may comprise, for example, a tool for the practitioner to digitally sign the application for electronic filing at the patent office 112 or to insert a digitized signature (i.e., an image of the signature) in the document where the signature would appear.

In a fourth step 508, the automated submission module 322 may encrypt the patent application before electronic filing at the patent office 112. Such encryption would provide security and ensure confidentiality as the patent application is electronically transmitted to the patent office 112 over the Internet 101.

In a fifth step 510, the aforementioned electronic transmission occurs. As illustrated in FIGS. 1A-1F, such electronic transmission from the smart filing server 107 or integrated IP server 122 to the patent office 112 may occur via the Internet 101.

In a sixth step 512, a notification of filing is transmitted to the automated calendaring module 334 in either the docketing server 108 or the integrated IP server 122. As described below in relation to FIG. 6, the notification is used to automatically calendar deadlines and reminders relating to the filing of the patent application.

Various steps in the method 500 for automated filing of a patent application at a patent office may utilize specifications and protocols available from the USPTO. For example, these specifications and protocols may include those related to the electronic filing system (EFS) of the USPTO.

FIG. 5B is a flow chart depicting a method 550 for automated submission of a defensive publication to a publisher in accordance with an embodiment of the present invention. The flow chart includes five steps. This flow chart is merely an illustration and should not limit the scope of the claims herein. One of ordinary skill in the art would recognize other variations, modifications, and alternatives.

In a first step 552, a single click instruction is received from the inventor. Such a single click may involve, for example, a press of a mouse button on an icon which indicates that the disclosure form is complete and ready for submission to the publisher. The single click instruction is received by the automated submission module 322. Alternatively, a verification step may be included in order to verify that the disclosure form is indeed ready for submission.

In a second step 554, the automated submission module 322 performs an automated conversion of the completed disclosure form into a format of a defensive publication according to the publisher's format requirements. The automated conversion utilizes information input by the user into various fields of the smart disclosure form and puts the information into the selected format of a publication.

For example, such a format may include: an abstract and drawings. In addition, the format may also include other documents payment authorization, etc. Other appropriate formats would be known by those of skill in the art and not presented in order to avoid obscuring the invention.

In a third step 556, the automated submission module 322 may optionally provide a mechanism for the publication submission to be executed by the person requesting publication. Such a mechanism may comprise, for example, a tool for inserting a digitized signature (i.e., an image of the signature) in the document where the signature would appear.

In a fourth step 558, the automated submission module 322 may encrypt the publication before submitting to the publisher. Such encryption would provide security and ensure confidentiality until such time as the publication is published.

In a fifth step 560, the aforementioned electronic transmission occurs. As illustrated in FIGS. 1A-1F, such electronic transmission from the smart filing server 107 or integrated IP server 122 may occur via the Internet 101.

Various steps in the method 550 for automated submission of a publication may utilize specifications and protocols available from the publisher.

FIG. 6 is a flow chart depicting a method 600 for automatic calendaring subsequent to the filing of a patent application in accordance with an embodiment of the present invention. The flow chart includes five steps. This flow chart is merely an illustration and should not limit the scope of the claims herein. One of ordinary skill in the art would recognize other variations, modifications, and alternatives.

In a first step 602, the automated calendaring module 334 receives notification of the patent application filing. For example, for embodiments where the automated calendaring module 334 is on a separate server from the automated filing module 322, the notification may be sent in the form of an electronic mail message from a mail server 324 on one server (i.e. the smart filing server 107) to a mail client 332 on the other server (i.e. the automated docketing server 108).

In a second step 604, if the notification indicates that the application filed was a provisional application, then the automated calendaring module 334 calendars a deadline for filing a utility patent application based on the provisional application. Such a deadline is, for example, one year following the provisional filing date, but would be dependent upon the appropriate and currently applicable patent laws.

In a third step 606, the automated calendaring module 334 calendars a deadline for filing foreign or international patent applications if applicable. Such a deadline might be, for example, one year after the original filing date, but would be dependent upon the appropriate and currently applicable patent laws.

Additional deadlines and reminders may also be calendared. For example, reminders to submit information disclosure statements for U.S. applications may be calendared. In addition, the response dates to Office Actions received from the Patent Office may also be calendared. The above described calendaring occurs by way of a database access module 336 which provides access to the calendar database.

Use of the calendared information is provided for in two ways corresponding to fourth and fifth steps 608 and 610. The first way 608 that the calendared information is used relates to actively transmitting reminders. Such reminders may be sent in the form of electronic mail from a mail server 324. The mail may be addressed to one or multiple recipients.

The second way 610 relates to providing secure access to the calendar of deadlines. Such access should be restricted (by way of passwords or otherwise) to only particular users. Access may be provided by way of a web server 314 and the database access module 336.

### System Architecture and Overview

FIG. 7 is a simplified block diagram showing the relationship between an IP data processing system 100 according to one embodiment of the present invention and participants in the patent process. The participants shown in FIG. 7 include technology developers 110, patent law firms 120, service providers 130, patent offices 140, prior art databases 150 and potential licensees 160. Other potential users, such as publishers for the defensive publications are also contemplated. As described in detail below, IP data processing system 100 is a web-enabled electronic platform that can be utilized by all participants in the patent process. Processing system 100 converts the paper-based patent prosecution system into an electronic workflow pipeline, allowing every step in the process to be executed from a computer desktop, lowering administrative costs and processing time for patent applications.

Processing system 100 provides technology developers 110 and its associated patent law firms 120 a highly secure, central data repository that may be shared between participants on an as-allowed basis. Information generated and used during the patent prosecution process may be shared between a technology developer 110 and appropriate patent law firm 120 and service providers 130 in order to create patent filings, prosecute such filings through issuance and then subsequently maintain patents after grant. Some specific functions provided by IP data processing system 100 include:

online creation of invention disclosures, witnessing, archiving and secure sharing of invention disclosures between technology developers and patent counsel;

automated conversion of invention disclosures into patent applications or technical publications;

instant electronic submission of such applications or publications in the PTO or technical publisher, giving inventions the earliest possible effective dates;

electronic filing and prosecution of patent applications in patent and offices worldwide, allowing all correspondence to and from patent offices to be paperless;

automated docketing in a standardized database accessible to all authorized participants;

electronic notification of due dates and electronic payment of annuity fees;

IP portfolio visibility, on-demand status reporting, and strategic IP analysis, extending not only to issued patents, but to invention disclosures and pending applications as well;

data mining of IP portfolios and targeting of potential licensees;

online receipt and examination of patent applications and issuance of office actions by patent offices worldwide; and

coordinating, tracking and providing payment options for all financial aspects of the patent process including patent office fees, attorney fees and service provider fees.

As mentioned above, in addition to IP data processing system 100, FIG. 7 shows various patent process participants including technology developers 110, law firms 120, service providers 130, patent offices 140, prior art databases 150 and licensees 160 connected to IP data processing system 100 through the Internet 50. For convenience, each of these participants is referenced by a dotted line that encompasses individual entities of the participant type. For example, technology developers 110 are shown in FIG. 7 as including individual technology developers 110(1), 110(2) through 110(n). It is to be understood that, while shown in FIG. 7 as a group, these multiple technology developers are separate entities that likely have no relation to each other than its classification within this patent application as developers of technology. It is also to be understood that, while not shown, each individual participant system typically includes its own firewall system that implements access control functions to isolate the system from unwanted intrusions by others.

Technology developers 110 include corporations, universities and individual inventors seeking to file patent applications, receive issued patents and publish defensive publications. Patent law firms 120 include U.S. patent attorneys, patent agents and foreign patent attorneys and/or agents. Service providers 130 include patent draftsman, prior art search companies, translation companies and other entities that provide services useful to the patent process as well as financial institutions and other parties that have tangential roles in the process. Prior art databases 150 include public and licensed private databases, such as online patent databases (e.g., issued U.S. patents, published European and Japanese patents, etc.) and non-patent databases. Patent offices 160 include patent offices worldwide including the USPTO, the European Patent Office (EPO), the Japanese Patent Office (JPO), the Taiwanese Patent Office, etc.

As shown in FIG. 7, IP data processing system 100 includes a web server 102a, a database 106a and paper mailroom 106b. Web server 102a includes a server engine 102b that generates and sends graphical documents including web pages 102c to client systems as requested and an electronic mailroom 102d. As used herein, a “client system” is a computer system that displays web pages generated by server engine 102b, e.g., through a browser residing on the client system. Thus, technology developers 110, patent law firms 120, service providers 130 and licensees 160 typically include one or more client systems within the group. For example, a corporation (technology developer) may have 150 inventors, 4 patent administrators and 2 in-house patent attorneys. Each of these individuals likely has their own computer system and can thus become a client system. Additionally, computers that are part of patent offices 140 can also be client systems in some embodiments of the invention.

Each client system can display the web pages generated by server engine 102b. Each of such web pages is uniquely identifiable by a Uniform Resource Locator (“URL”) and is stored in a computer-readable memory (not shown) accessible to the server engine. To view a specific document, including a web page, a client system uses a web browser executing on the client system to specify the URL for the document in a request (e.g., an HTTP request) as is known to those of skill in the art. The request is forwarded to the web server supporting the document (server system 102a in this instance), which when it receives the request, sends the requested document to the client system. The web browser may then display a web page contained in the document, e.g., HTML document.

Database 106a stores all information pertaining to the patent developers' intellectual property portfolios. Patent process participants (such as the technology developer employees and outside law firm personnel) access this information as needed and only to extent that their access rights permit. The information in database 106a includes draft and completed invention disclosures, draft and completed patent application documents, messages and discussions pertaining to invention disclosures and patent applications, patent and patent application status information, prior art publications, etc.

IP data processing system 100 communicates with patent offices 140 over the Internet 50 through electronic mailroom 102d and through standard snail mail (e.g., U.S. Postal Office Express Mail) using paper mailroom 106b. For such communications, system 100 sets the correspondence address to mailroom 102d or 106b so that replies to the communications can be tracked and entered into database 106a as described below.

Electronic mailroom 102d is part of server 102a and includes a suite of programs that interface to the standards set by each patent office 140. For example, in order to file patent applications electronically through the USPTO the system comports to the standards required by the USPTO's Electronic Filing System (“EFS”). This includes using the Electronic Packaging and Validation Engine (“ePAVE”) or compatible software to facilitate electronic filing. Complete details of the ePAVE software are available online through the USPTO's Electronic Business Center website at http://pto-ebc.uspto.gov/. Also, in order to track and update status information for pending patent applications, such as Examiner name, assigned art unit and class/subclass, etc., electronic mailroom 102d has the ability to interface to USPTO's Patent Application Information Retrieval (“PAIR”) system using appropriate digital certificates. Electronic mailroom 102d also includes other programs to interface with other patent offices.

Paper mailroom 106b includes printers, fax machines and other appropriate equipment to carry out all the duties necessary to file patent applications and other formal papers in patent offices using standard mailing and filing procedures. Paper mailroom 106b also includes scanners and equipment necessary to scan papers received from technology developers 110, patent attorneys 120, and patent offices 140 into computer-readable format. Such correspondence may be scanned and analyzed by optical character recognition (“OCR”) software to create two version of the document: an image version and a text versions created by the OCR software. The OCR software is calibrated to recognize particular fields within common Patent Office forms to capture data from those forms so that appropriate data (e.g., due dates, Examiner's name, Applicant, application no., etc.) from such papers can be parsed and entered into database 106a. To this end, the fields of various Patent Office forms that are scanned by mailroom 106b are mapped to database 106a along with the document type (determined from the form recognition sequence) in order to enable the system to determine the appropriate docketing deadlines. Alternatively, or in addition to such scanning, personnel in mailroom 106b can directly enter appropriate data into database 106a using computers or data entry terminals coupled to the database through a local area network or similar network. Once scanned into computer-readable format, communication between IP data processing system 100 and technology developers 110 can proceed in a manner that, from the standpoint of a technology developer, seems entirely paperless.

IP data processing system 100 also provides a conduit through which potential licensees 160 may purchase technology from technology developers 110. This conduit may include both general access to the public as well as subscription access. For example, an individual technology developer 110(x) may decide to place selected IP assets into the access area for review by any interested party. In this case, IP data management system lists the selected assets on appropriate web pages generated by server engine 102 and allows public access to the assets to any client system browsing the pages. Other technology developers (e.g., prolific universities) may decide to enter arrangements with priority licensees such that these priority licensees pay a subscription fee to the university for “first look” rights at new IP assets. Under this arrangement, the priority licensees will be able to access appropriate data describing the IP assets (e.g., title, abstract, claims, inventor list) through web pages that have restricted access rights and are thus not viewable to the general public (i.e., non-priority licensees). As will be appreciated by those of skill in the art, a technology developer could use a combination of these systems for making its inventions available to potential licensees.

### Workflow in IP Data Processing System 100

IP Data Processing System 100 may provide an automated work flow processing system that enables workflow to be tailored for organizations and/or individuals. The workflow process is the process of routing documents to predetermined users, notifying the appropriate users of required tasks, periodically reminding users of task completion deadlines, and tracking time periods associated with both tasks and the time between tasks, all according to a customer-defined workflow process design. Workflow examples include the circulation of invention disclosures to a review committee for filing decisions, routing of invention disclosures to a working attorney for drafting patent applications, circulation of draft patent applications to inventors and managers for review and comment, circulation of Patent Office forms to inventors and managers for signature, notification of attorneys of the receipt of Patent Office actions and papers, and routing of documents to service providers (e.g., informal drawings to a draftsperson for creation of formal drawings) as needed.

### Document Management

IP Data Processing System 100 may provide document management system that enables assembling and managing of documents. In this system, much of the information is organized into Document Entities. A Document Entity is a high-level description of a type of document that is created, manipulated, reported, tracked, etc. by IP data processing system 100. Each Document Entity is described by a collection of rules that define necessary attributes including data fields that must be complied with/populated for the given Document Entity to be considered complete, such as unique identifiers for the document and the relationship between that document and other documents in system 100. The document management function of IP data processing system 100 implements the access, edit and version control rules for all Document Entities in the system. Some of these rules may default to predefined rules while others are set in the user set-up process described above.

A Document Entity is created when it is given a unique set of the attributes listed in the Entities Table. When a Document Entity is created within the context of a case (i.e., the electronic file that is created in conjunction with creation and/or submission of an invention disclosure, discussed supra), the Document Entity acquires some of its attributes from that case. Any other required Document Entity attributes must be entered by the user before the Document Entity creation step is complete.

A Document Entity may be created before or after the underlying file is created. When a client system requests the creation of a new word-processed Document Entity, IP data processing system 100 creates a new Word (WordPerfect, or other word processing document) document and passes the client system into that document after all required Document Entity attributes have been acquired or entered. Version and tracking control are provided to enable a user to track a document, such as invention disclosure data document or file, as it is routed through the system for review, modification, and approval. Importantly, the document can be reviewed either sequentially or concurrently by inventors, as will be discussed in more detail below.

System 100 also includes an archival function that saves and locks all documents submitted to and received from patent offices so that they cannot be subsequently altered as well as an MIS log function that generates an “audit trail” that records events in a separate database table, including who, what object, what time, and what was done (read, write, edit, witness) to all documents for all customers.

The way that a Document Entity is managed will depend on the Document Entity attributes that are associated with that Document Entity at creation or thereafter. Relevant attributes include, for example: document type, status and security profile. For example, an invention disclosure (whether created by the Invention Disclosure Wizard or otherwise) can be edited only by one of the inventors for that invention, and the invention disclosure may be locked down such that it cannot be edited after it has been finalized and witnessed. As another example, draft patent application specifications (typically MS Word or WordPerfect documents) may be set up to be edited only by the originator, or may allow for an editable version to be routed to co-inventors for review and comment. All others who have authority to access the draft patent application will be able to edit new versions of the document. It should be noted that some documents sent from system 100 to patent offices 140 are actually collections of Document Entities. For example, an electronic patent application comprises a collection of Document Entities including word-processed document files (e.g., a patent specification), form-based document files (e.g., a transmittal form) and image files (e.g., figures).

When a client system requests the creation of a form-based Document Entity, IP data processing system 100 populates specific fields of the form as appropriate. For example, if the user is working on a filing for a particular case and creates a Transmittal Form for that filing, creation of the Transmittal Form Document Entity within the context of that case and that filing will cause the inventor, Patent Office Application Number, external and/or internal docket number, invention title, filing date, art unit, and Examiner name fields to be populated from the attributes of the case. The underlying document file is also created for further preparation and finalization by the user. The system will prompt the user for specific information for unpopulated fields or confirmation (and validation) of populated fields.

IP data processing system 100 may include various form “wizards” for assisting client systems with the completion of numerous government applications and forms. System 100 also includes software to “map” the data from the form wizards to the forms themselves so that the users can switch from the “wizard view” to a what-you-see-is-what-you-get (“wysiwyg”) view. Additionally, some of the wysiwyg views will have direct editing capability of selected fields.

There are a variety of documents that will not be created within the IP data processing system 100. Accordingly, system 100 provides a sophisticated document upload process. The upload process provides the correct Document Entity designation. Uploaded documents fall into two major categories: (1) documents created electronically, but not within the IP data processing system 100; and (2) paper-based documents.

Electronic documents that are uploaded into system 100 include patent applications, amendments, requests for reconsideration and other text-based documents prepared by client systems in MS Word or WordPerfect. These documents become Document Entities once they are in IP data processing system 100. Drawings are part of almost every patent application filed. Many drawings are prepared using some kind of graphics software. IP data processing system 100 system converts such graphic images to a common file format (such as PDF) to allow access for all necessary participants. In addition, the original format will be retained for use with (e.g., revisions to) the original graphics tool.

As previously mentioned, system 100 also provides for paper documents to be scanned and/or uploaded into database 106. The current USPTO EFS does not provide office actions and other USPTO correspondence in electronic form. Rather, these mailings are made in hard copy only. Such hard copies of USPTO correspondence are uploaded into IP data processing system 100 through paper mailroom 106b. The current USPTO EFS also requires inventor declarations (the documents in which the inventors state that they are the actual and first inventors of the patent application's subject matter) to be signed by hand; scanned and uploaded as electronic documents for filing. As the USPTO and other patent offices permit the electronic communication of more and more documents between applicants and the patent offices, such uploads into system 100 may no longer be necessary. For example, the system 100 could receive electronic correspondence from the patent office via a virtual private network connection, fax transmission, email, or over the Internet.

Other types of paper documents that may be scanned and uploaded into system 100 include invention disclosures that are typed, handwritten or otherwise created in other than electronic form; handmade formal or informal drawings; and any correspondence, memos and notes associated with a patent application created in hard copy outside IP data processing system 100 that are associated with the corresponding patent application file and desired to be tracked in system 100.

### Message Boards/Alerts

IP Data Processing System 100 may provide for an Alert system. One of the primary features of IP data processing system 100 is its ability to facilitate communication between all parties associated with the patent process and its ability to notify users of alerts associated with cases assigned or associated with a user. Alerts include calendared docket items (e.g., due dates), messages (such as internal messages), threaded discussions, and assigned tasks. To this end, the web pages generated by IP data processing system 100 and displayed to client systems includes an alert board that tracks and displays such communications and notices to the user. The alert board also provides the ability to conduct off-line discussions pertaining to cases and Document Entities within cases. In one embodiment, these alert board are available to and can be presented to all registered client systems of system 100. The content of the alert board, however, varies from client system to client system as the boards displays messages, discussions, calendared docket items, and tasks that are specific to each client system.

In one embodiment Discussion Items are posted and linked to a topic and to each other as in a threaded discussion model. Like Document Entity attributes, the Discussion Items contains attributes that connect the Discussion Items to the cases and specify access and security rules. Discussion Items are an alternative to email and may be used in addition to the internal messaging function. Discussion items typically include the ability to have a threaded discussion. Tasks may also be created to send a message notifying a recipient that he or she has been assigned a project or task to perform in conjunction with the case. The user can specify who can see or respond to a given discussion item. Discussion Items are tracked and displayed like a Document Entity in the Alert Monitor as well as in the electronic case file.

One of the more common alerts that is sent to individual client systems through the alert board is docketing reminders. Docketing is the heart of managing patent information because it tracks calendared due dates. The docketing engine of IP data processing system 100 manages the calendar of due dates for all the cases tracked by the system and allows practitioners to keep track of the meta data for the case (i.e., bibliographic information) as well as the progress of a case the relationship between cases and due dates. The docketing software tracks meta data and date information for all cases. The user can access meta data for a case through the electronic case file. Meta data is case summary information including bibliographic information. Some examples of meta data fields are, for example, title, application number, filing date, etc. The software includes an engine that implements rules associated with the docketing process.

Notification of impending deadlines for cases is sent to client systems through the alert board. Users are provided notification of both reminder deadlines as well as the due dates for calendared items. The frequency of reminders leading up to Patent Office deadlines may be determined by the client during the user set-up process as part of the client or user's workflow definitions. Deadlines may be defined and utilized by the IP data processing system 100 based on, for example, disclosure or publication dates contained in the invention disclosure data, dates documents are transmitted to an patent office, or other deadlines defined based on dates documents are mailed from patent offices or received by IP data processing system 100. For example, the date a patent application is first submitted to a first official patent office may trigger deadlines for filing the application in foreign patent offices where novelty has been preserved. Similarly, the date an Office Action is mailed from an official patent office typically triggers a due date for submitting a Response to that Office Action. Likewise, the date the invention is offered for sale, published, or disclosed may also trigger a due date for filing an application in a Patent Office.

For each such deadline or due date a new docket entry is created that reflects the action that needs to be resolved by the deadline. When documents are received electronically by system 100, appropriate docket entries are created automatically. When paper documents are received and scanned into the system docket entries can either be created automatically from the scanned information that is parsed into database 106a or docket entries can be created by personnel in paper mailroom 106b. If created manually, it is preferable that only actions types that have been defined for the country in which the case has been filed in are available for selection when the mailroom 106b employee enters a task type in a particular case. Further, the action types available may be further limited as a result of the application type (e.g., provisional, utility, design), application status (e.g., pending, issued, etc.), or such other parameters as may be desirable.

In most cases, based on business rules and the document type, a series of reminders and due dates are created for the docket entry. These reminders and due dates appear in the alert board of an appropriate client system as a list of outstanding docket entries that require response. There are some cases where an ad hoc action would be generated in association with a particular case. The reminders and due dates may be calculated based on, for example, the date of the document, the date of the application, the date of the patent, or the date of the priority application, or the earliest priority application (where there are multiple cases). Typically there is an ability to designate responsibility for completing the docket entry in the system. In one implementation, system 100 identifies the document type from the scanned image or electronically received document and automatically associates a docket entry in response to the scanned document.

There are two types of dates typically associated with a docket entry. The first is a reminder (soft date), the second is an actual due date (hard date). In one embodiment, customers are able to select an option where reminders appear on the alert board only until the date of the reminder and then automatically lapse in favor of the actual due date or a later reminder. Actual due dates, however, are removed from a client system's alert board by either extending the due date (manually), by indicating that task was completed (e.g., the Response was filed) or by assigning the docket entry to another client system that acknowledged and accepted the assignment of responsibility.

### Functions Commonly used by Inventor Client Systems

In addition to the alert board discussed above, another function available to an inventor client system at a given technology developer 110(x) is the creation of an invention disclosure on IP data processing system 100. IP data processing system 100 supports two ways of creating invention disclosures. The first is an upload of a document created outside the system using the Document Upload process described below. The second is the Invention Disclosure Data Wizard. When launched, the Wizard advises the inventor if there are invention disclosures in the drafting process and asks whether the inventor wishes to further revise a pending disclosure or create a new one. The Invention Disclosure Data Wizard walks the inventor through a process for obtaining invention disclosure data by prompting a user with one or more questions per screen and providing a space for the inventor to enter invention disclosure data. Electronic files such as Word® documents, drawings, patents, or other literature, may be uploaded and attached to the invention disclosure and associated with the answers to the wizard questions. A help function is also provided to provide further explanations of individual questions. The answers to the questions become invention disclosure data, which may be html-coded fields mapped to database 106a. Portions of the invention disclosure data may be used by other system resources for such things as licensing, docketing, generating information disclosure documents, case management, or automatic generation of patent applications or defensive publications. The system allows administrator customization of the questions asked by the Wizard and the order in which they are asked. The system also allows individual questions to be skipped and answered later in an order different from that originally presented. In one embodiment, there is a basic and expert version of the Wizard. In the expert version of the system, explanatory text is removed to allow more experienced users to proceed through the disclosure process more rapidly.

Once the invention disclosure is entered into IP data processing system 100, routing rules previously entered through a setup process determine what sequence of events are triggered. For example, according to one possible set of routing rules, where the inventor who fills out the invention disclosure lists several other co-inventors, the invention disclosure is given a unique identification number and routed to each inventor for approval or modification as well as to an appropriate engineering manager. Once approved by each of these parties, a copy of the disclosure is archived, date-stamped and locked to prevent further changes. In one embodiment discussed in more detail below, the IP data processing system 100 tracks the history of all versions of the invention disclosure data entered by each inventor or participant. The invention's history may then be tracked for purposes of establishing conception and diligence in reduction to practice which may be useful information in subsequent prosecution or interference proceedings. The completed disclosure data may then be forwarded to an in-house attorney for review and, once attorney approval is obtained, automatically converted into a provisional application, non-provisional application, or defensive publication (by, e.g. porting specific portions of the information disclosure data into a new document). Non-provisional applications may be automatically filed in the USPTO using the currently established electronic filing procedure; other applications may be filed by mail. For provisional applications, an appropriate message may then be routed to the patent lawyer 120(x) assigned to prepare the non-provisional application.

In one embodiment, there may be several possible outputs from the Invention Disclosure Data Wizard. First is the invention disclosure itself, which shows the questions, the answers, and any data entered automatically by IP data processing system 100 (such as document creation date and document completion date). The second is an automatically generated patent application specification (either a provisional application or a regular non-provisional application as defined by the routing rules) or defensive publication. Additionally, portions of the invention disclosure data may be used by an information disclosure tool, licensing analysis tool, or docketing tool. Furthermore, portions of the invention disclosure data may be processed and used in a case management tool.

Another function presented to the inventor is internal and external searching through various databases 150 including technical reference and patent databases. IP data management system 150 allows client systems to search through databases 150 using a common search engine and single search interface. This greatly simplifies the search process so that client systems are not required to learn different search engines for each different database that is searched. Additionally, system 150 allows a client system to define a search and then select which databases are to be searched. The selection mechanism allows for all databases to be searched, just patent databases, just technical journal databases and almost any other combination.

If the search function is executed during creation of an Invention Disclosure or after an Invention Disclosure has already been submitted, the process allows the client system to associate results from the searches with the reference number for the Invention Disclosure. When references are associated in this manner for a case that already has been submitted to a patent attorney for preparation (or a case in which a patent application has already been prepared and filed), a message alert is automatically created and sent to the appropriate attorney client system. This enables the attorney client system to either review the references prior to or during preparation of the patent application or, if an application has already been submitted, review the references to decide whether an Information Disclosure Statement (“IDS”) should be prepared and filed for the case. One way of allowing an inventor client system to associate references with a particular Invention Disclosure is to save the search results as a file, upload the file and associate the file with the Invention Disclosure.

Another method of associating specific references with an Invention Disclosure is through a reference shopping cart. In one embodiment such a reference shopping cart is displayed on the search web page. The web page then allows the client system to select a bibliographical entry (e.g., the title) for an individual references and drag the entry to the reference shopping cart. If the client system has already associated the searching function with a particular Invention Disclosure the reference becomes associated with that disclosure automatically. If no particular Invention Disclosure was identified as the subject of the search, however, the client system is prompted to identify an Invention Disclosure once a reference has been added to the shopping cart. In another embodiment, references are added to the shopping cart by selecting the reference and then selecting an icon such as “add to reference shopping cart.” System 100 includes a software module that parses the necessary data from the prior art database 150 into fields appropriate for an IDS. When an attorney client system selects to create an IDS from such data, system 100 populates all appropriate fields of the IDS with the parsed data. In still another method, where the IDS is sent electronically to an official patent office, system 100 saves each reference identified by the inventor client system in database 106 and creates an IDS form (e.g., a PTO Form 1449) that includes html links to the saved document in database 106. The html links may be populated, for example in a field that uniquely identifies each reference (e.g., the patent number for a patent document). When a Patent Examiner then views the document electronically, the Examiner can select the html link to see the reference on his or her computer thereby eliminating the need to send and/or print paper copies of the references.

### Invention Disclosure Data Wizard

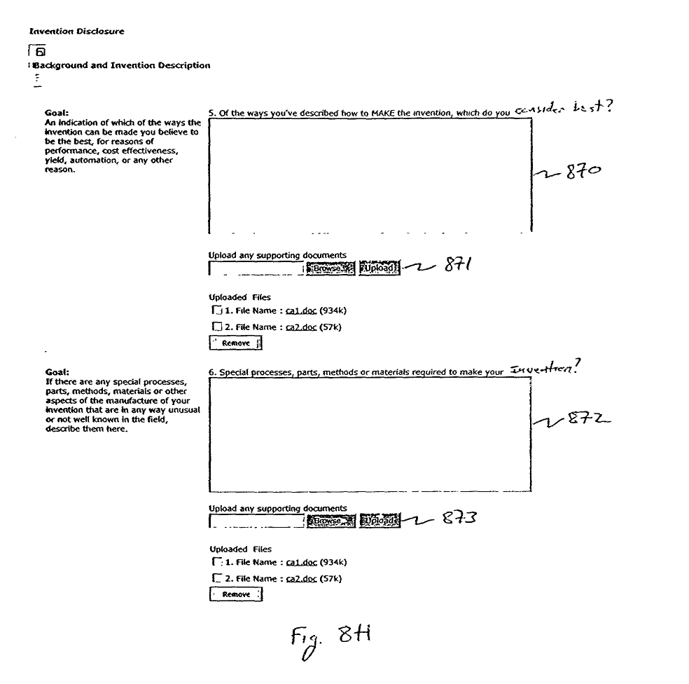

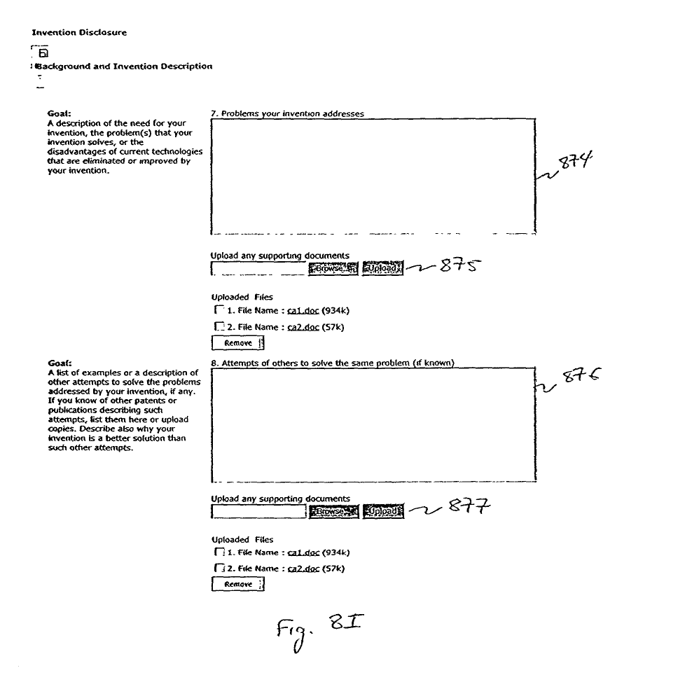

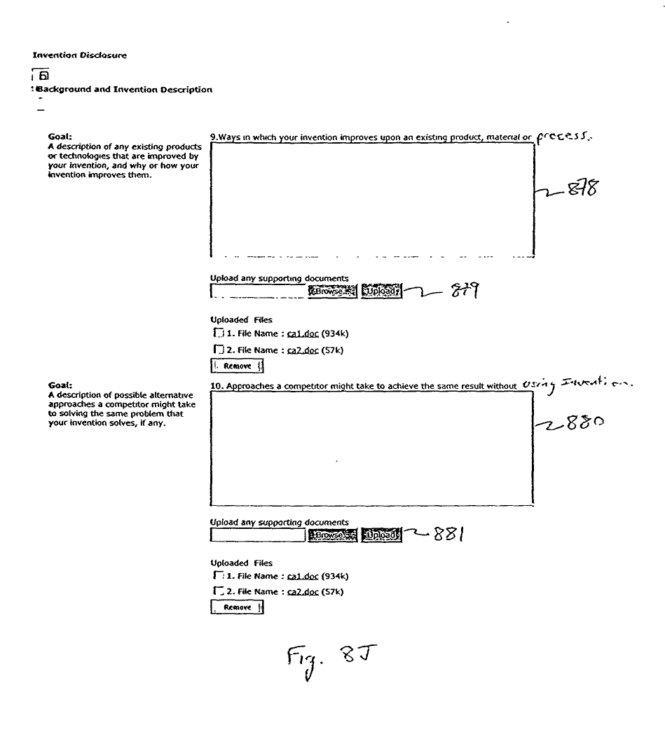

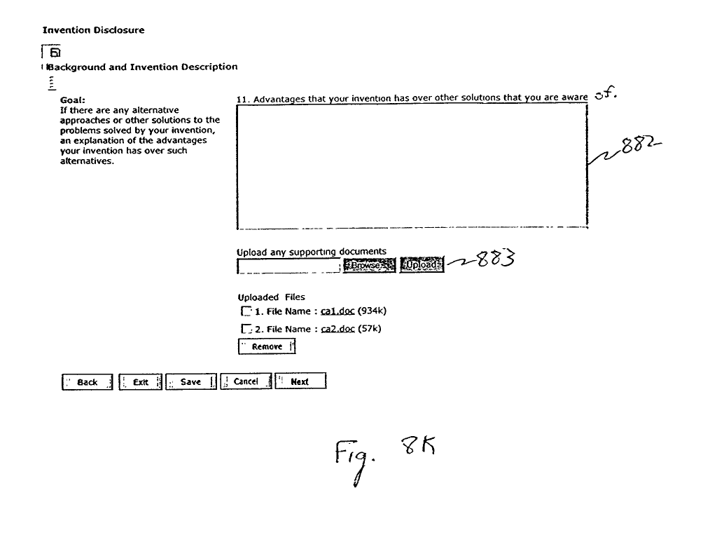

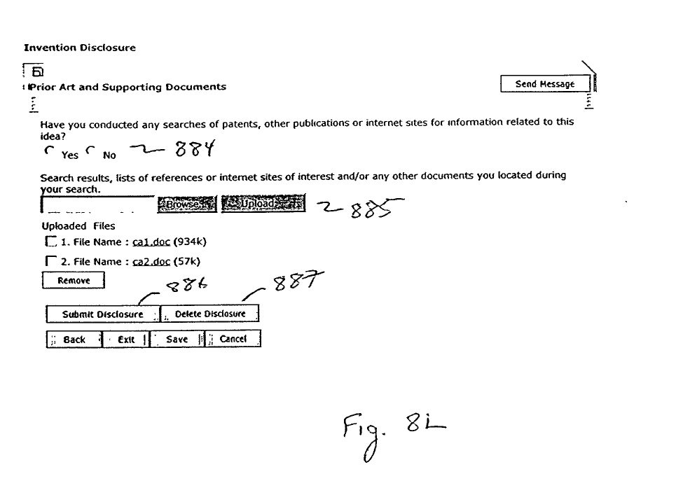

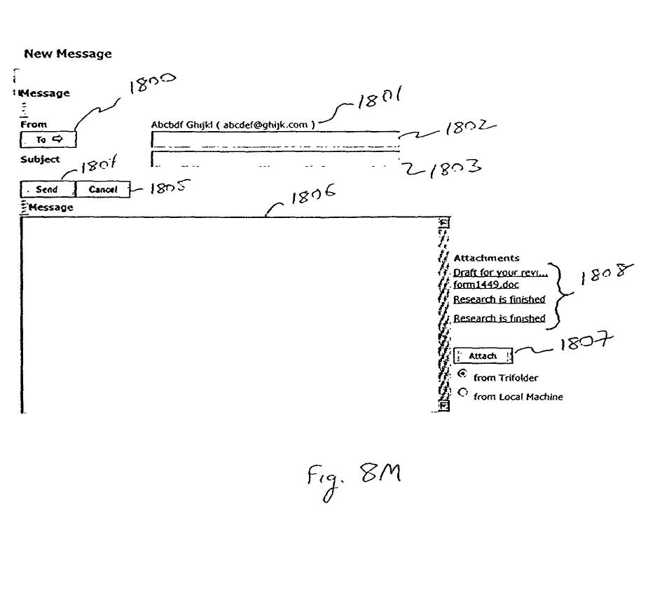

FIGS. 8A-8M are example web pages 104 generated by a server engine 102 in IP data processing system 100 of FIG. 7 to process invention disclosure data according to one embodiment of the present invention. These Invention Disclosure web pages may be presented to a user on a client system when the client system activates the Invention Disclosure Data Wizard by selecting an icon (e.g., an html link) from a web page presented to the client system.

FIG. 8A illustrates an invention disclosure manager 80a according to one embodiment of the present invention. The invention disclosure manager 80a may include a display of existing disclosures 800. Each existing disclosure may be displayed as an html link to the invention disclosure data document. The invention disclosure manager 80a may also include a link for starting a new disclosure 801, and a link for uploading an existing disclosure 802 from a client system to the server system. A Send Message button 803 may also be included as part of the invention disclosure manager 80a, as well as one or more of the other invention disclosure web pages discussed below. The Send Message button 803 may invoke an internal messaging system for communicating information about the invention disclosure data to other users associated with the invention disclosure.

FIG. 8B illustrates an Invention Disclosure Data Wizard Index 80b according to one embodiment of the present invention. The Wizard Index may include links to each of the individual Invention Disclosure web pages. In one embodiment, the Wizard Index 80b includes an invention disclosure data manager link 810, a inventor information screen link 811, links to each of two Preliminary Invention Information web pages 812, links to each of six Background and Invention Description web pages 813, a Prior Art and Supporting Documents link 814, and a Disclosure History link 815. The Wizard Index 80b may be displayed simultaneously on each of the Invention Disclosure web pages, thereby allowing users of the system to quickly access individual sections of the invention disclosure data. This has the benefit of allowing a user to enter the invention disclosure data either in a fixed order, or alternatively, to skip between sections and enter the invention disclosure data in the order that such data is made available to the user. Additionally, different users may add different data depending on their relation to the invention project. For example, a technical person may add data for the technical invention specification portions of the invention disclosure data, a business person may add information on market value of the invention and potential licensees, and an applications person may add information on potential applications and licensees.

FIG. 8C illustrates an Inventor Information screen 80c according to one embodiment of the present invention. The Inventor Information screen 80c may include a field identifying the inventors company 820, a Group field 821 indicating the group the inventor works in at the company, an Inventor Type field 822 indicating employment status of the inventor (e.g., employee, contractor, etc . . . ). An Inventor Selection field 824 may be provided for selecting the inventor's name from the list of all possible inventors associated with a particular company. If the desired inventor is not listed, an Add Unlisted Inventor button 819 is provided for adding an inventor. In response to selecting the Add Unlisted Inventor button 819, another web page may be displayed for adding the inventors name, company, home address, or other information useful for the patent process (not shown). Inventors may be added to the inventor invention disclosure data selecting one of the names in the Inventor Selection field 824 and mouse clicking or otherwise selecting the Add button 819b. Accordingly, the selected inventor's name will appear in the Inventor field 823. Inventors may also be removed by mouse clicking or otherwise selecting the Remove button 819c. Inventor Information screen 80c may also include a Back button 825 for returning to the previous web page, an Exit button 826 for exiting the Invention Disclosure web pages, a Save button 827 for saving the current invention disclosure data, a Cancel button 828 for canceling current actions, and a Next button 829 for moving to the next subsequent web page.

FIG. 8D illustrates a first Preliminary Invention Information screen 80d according to one embodiment of the present invention. The Invention Information screen 80d may include a Title field 830 to prompt the user for a short, descriptive title of the invention, a Project field 831 indicating the project that the invention relates to, and a Product Name field 832 indicating the name of the product or products that the invention will be implemented in. An Interested Companies field 833 may be provided for identifying any companies that may be interested in the invention. Such information may be later extracted by a licensing tool for use in implementing automated licensing identification and development functions of IP data processing system 100. The Invention Information screen 80d may also include a Publication field 834 indicating the date of past or anticipated publication date for a publication disclosing the invention. Additionally, a Disclosure field 835 may be included to track the date of other non-publication disclosures outside the company. A Confidentiality field 836 may be provided for tracking existence or non-existence of non-disclosure confidentiality agreements. The date of the confidentiality agreement may be entered into the information disclosure data in Agreement Date field 837. Additionally, one or more confidential agreements may be uploaded into the invention disclosure.

FIG. 8E illustrates a second Preliminary Invention Information screen 80e according to one embodiment of the present invention. The Invention Information screen 80e is a continuation of Invention Information screen 80d and may include a confidentiality Agreement Identification field 840 prompting the user for an identification of the confidentiality agreement. Additionally, the agreement may be uploaded by mouse clicking Upload button 843. A user may browse a local or remote network (e.g., the IP Data Processing System 100 or company network) for specific confidentiality agreements by mouse clicking the Browse button 842. The name of the selected agreement will appear in the Upload Agreement field 841, and a user may commence with the uploading by mouse clicking the Upload button 843. For the case of uploaded documents here and in other sections of the Invention Disclosure Data Wizard, the uploaded documents may appear as a list below the Upload fields. Agreements may also be removed by mouse clicking the Remove button 844.

FIG. 8E also illustrates how critical information relating to an invention's conception and reduction to practice may be entered into the invention disclosure data for use by other portions of the IP Data Processing System 100 according to embodiments of the present invention. A Prototype field 845 is provided to prompt the user to enter the date of the first working model or prototype. Additionally, Invention Information screen 80e includes a Start Testing field 846 to enter when testing first indicated that the invention worked. A positive Test Result field 847 may be used to prompt a user for the date that testing first indicated that the invention worked. Additionally, a Government Contract Number field 848 may be provided for entering the government contract number into the invention disclosure data if the patent application is under a government contract. Accordingly, Government Contract Upload field 849 may be provided for uploading such documents if they exist.

FIG. 8F illustrates one web page 80f for the Background and Invention Description according to one embodiment of the present invention. The Background and Invention Description Screen 80f may include a Detailed Description field 850 prompting the user for a detailed description of the design, construction, and operation of the invention. Additionally, the supporting documents, such as drawings or references, may be uploaded by mouse clicking Upload button 851. The Background and Invention Description screen 80f may also include an USE field 852 prompting the user for a description of potential uses and applications of the invention. The USE field 852 is particularly advantageous because it specifically prompts the user to enter a description of how to “use” the invention, which is necessary for meeting Enablement Requirement of 35 U.S.C. 112. Additionally, the supporting documents, such as drawings or references, may be uploaded by mouse clicking Upload button 853.

FIG. 8G illustrates another web page 80g for the Background and Invention Description according to one embodiment of the present invention. The Background and Invention Description Screen 80g may include a Best Use field 860 prompting the user for a description of the best use the invention from the potential uses described in USE field 852. The Best Use field 852 is particularly advantageous because it specifically prompts the user to enter a description of which “use” of the invention is subjectively considered the “best use” by the inventor, which is necessary for meeting Best Mode Requirement of 35 U.S.C. 112. Additionally, the supporting documents, such as drawings or references, may be uploaded, for example, by mouse clicking Upload button 861. The Background and Invention Description screen 80g may also include a MAKE field 862 prompting the user for a description of how a person with a reasonable level of skill in the field of the invention could make the invention. The MAKE field 862 is particularly useful because it specifically prompts the user to enter a description of how to “make” the invention, which is also necessary for meeting the enablement requirement of 35 U.S.C. 112. Additionally, the supporting documents, such as drawings or references, may be uploaded by mouse clicking Upload button 863.

FIG. 8H illustrates another web page 80h for the Background and Invention Description according to one embodiment of the present invention. The Background and Invention Description screen 80h may include a Best Mode of Making field 870 prompting the user for a description of the best mode of making the invention from the potential modes described in MAKE field 862. The Best Mode of Making field 870 is particularly advantageous because it specifically prompts the user to enter a description of which mode of “making” the invention is subjectively considered the “best mode” by the inventor, which is also necessary for meeting best mode requirement of 35 U.S.C. 112. Additionally, the supporting documents, such as drawings or references, may be uploaded by mouse clicking Upload button 871. The Background and Invention Description screen 80h may also include a Special Procedures field 872 prompting the user for a description of any special processes, parts, methods, or materials required to make the invention. Additionally, the supporting documents, such as drawings or references, may be uploaded by mouse clicking Upload button 873.

FIG. 8I illustrates another web page 80I for the Background and Invention Description according to one embodiment of the present invention. The Background and Invention Description screen 80I may include a Problems Solved field 874 prompting the user for a description of the problems addressed and solved by the invention, need for the invention, or the disadvantages of current technologies that are eliminated or improved by the invention. The Problems Solved field 874 is particularly advantageous because it specifically prompts the user to enter a description of key information that may be useful for establishing patentability of the invention, for example under 35 U.S.C. 103. Additionally, the supporting documents, such as drawings or references, may be uploaded by mouse clicking Upload button 875. The Background and Invention Description screen 80h may also include an Attempts of Others field 876 prompting the user for a list of examples or description of other attempts to solve the problems addressed by the invention. The Attempts of Others field 876 is particularly advantageous because it specifically prompts the user to enter a description of additional key information that also may be useful for establishing patentability of the invention, for example under 35 U.S.C. 103. Additionally, the supporting documents, such as drawings or references, may be uploaded by mouse clicking Upload button 877.

FIG. 8J illustrates another web page 80j for the Background and Invention Description according to one embodiment of the present invention. The Background and Invention Description screen 80j may include an Improvements field 878 prompting the user for a description of the any existing products or technologies that are improved by the invention. Additionally, the supporting documents, such as drawings or references, may be uploaded by mouse clicking Upload button 879. The Background and Invention Description screen 80j may also include an Alternative Approach field 880 prompting the user for a description of possible alternative approaches a competitor might take to solve the same problem solved by the invention. The Alternative Approach field 880 is particularly advantageous because it specifically prompts the user to enter a description of additional key information that also may be useful for aiding a patent practitioner (e.g., Patent Attorney or Patent Agent) in drafting and supporting broad claims to fully protect the full scope of the innovative concepts of the invention. Additionally, the supporting documents, such as drawings or references, may be uploaded by mouse clicking Upload button 881.

FIG. 8K illustrates another web page 80k for the Background and Invention Description according to one embodiment of the present invention. The Background and Invention Description Screen 80k may include an Advantages field 882 prompting the user for a description of the any alternative approaches and advantages of the invention over such alternative approaches. Additionally, the supporting documents, such as drawings or references, may be uploaded by mouse clicking Upload button 883.

FIG. 8L illustrates a web page 80l for the Prior Art and Supporting Documents section of the Invention Disclosure Data Wizard according to one embodiment of the present invention. The Prior Art and Supporting Documents section 80l may include Search field 884 for designating whether or not a search of patents, other publications, or Internet sites has been carried out. Additionally, Search Result field 885 may be included for attaching documents, such as prior art patents, printed publications, or Internet URL's to the invention disclosure data. Such documents may be uploaded by mouse clicking Upload button 883. In one embodiment, the Prior Art and Supporting Documents section includes a Submit Disclosure button 886 and Delete Disclosure button 887. The Submit Disclosure button 886 may be mouse clicked to invoke the information disclosure tool. The information disclosure tool, as described in more detail below, may process the information disclosure data elements (e.g., attached prior art patents, printed publications, internet URL's) to generate an information disclosure statement.

FIG. 8M illustrates a Message web page 80m for the internal IP data processing system messaging system according to one embodiment of the present invention. The internal messaging system may be used for communicating information about the invention disclosure data to other users associated with the invention disclosure. The Message web page 80m includes a From field 1801, a To field 1802, and a Subject field 1803. Intended recipients of messages may be selected by mouse clicking the To button 1800, which may present a user with a menu of internal users of the system (not shown) who may receive information about the particular invention disclosure data of the currently active invention. Messages may be transmitted by mouse clicking the Send button 1804 or canceled by mouse clicking the Cancel button 1805. The Message web page 80m also includes a Message Body field 1806 into which a user may enter the text of the message to be sent. Attachments to the message may be attached to the message by mouse clicking the Attach button 1807. The Attach button 1807 may access documents from the case management portion of the IP Data Processing System (e.g., the case Trifolder), or alternatively, from a local machine. Documents current attached to the message are listed as “Attachments” at 1808.

### Invention Disclosure Data Processing and Management

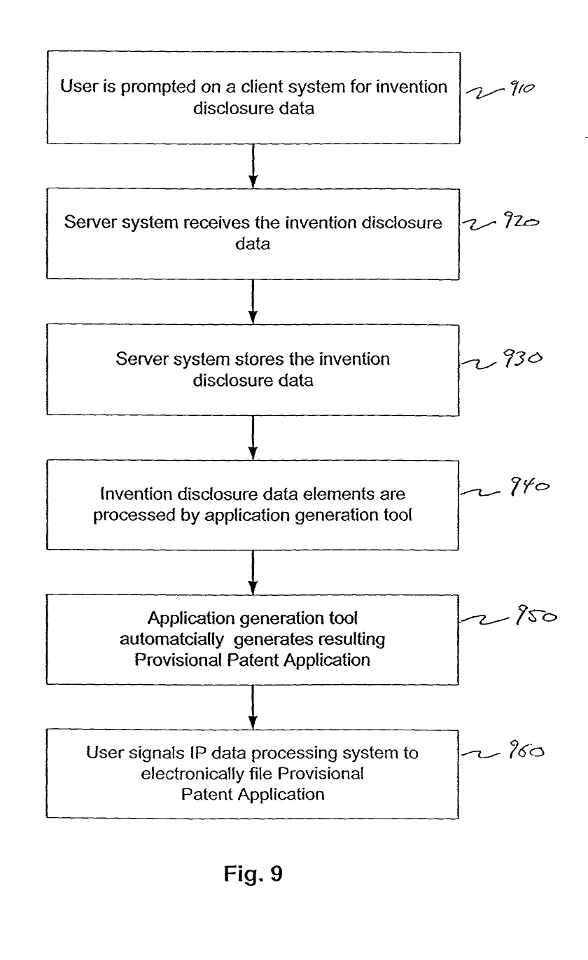

Features and advantages of the combination of the Information Disclosure Data Wizard and Internal IP data processing messaging system include the ability to quickly and efficiently manage the generation and submission of new invention disclosures both to internal intellectual property groups in an organization, as well as to one or more Official Patent Offices. FIG. 9 illustrates a computer-implemented method of processing disclosure data according to one embodiment of the present invention. At step 910 a user may be prompted on a client system for invention disclosure data as outlined above. At step 920, the server system receives the invention disclosure data. At step 930, the server stores the invention disclosure data (e.g., when the Save button is mouse clicked). At step 940, invention disclosure data elements of the invention disclosure data are processed by an application generation tool. For example, out of all the invention disclosure data entered into web pages 8A-8M, particular invention data elements (e.g., data in the web page fields) of the invention disclosure data may be referred to as “invention specification data elements.” Namely, invention data elements of the invention disclosure data that may be used in a patent application or defensive publication may be referred to as invention specification data elements. Invention specification data elements may include Inventor Information, Title, detailed description field 850, USE field 852, Best Use field 860, MAKE field 862, Best Mode of Making field 870, Special Procedures field 872, Problems Solved field 874, Attempts of Others field 876, Improvements field 878, Alternative Approach field 880, and Advantages field 882. The application generation tool may automatically generate a provisional patent application at step 950. At step 960, the user may signal IP data processing system 100 to electronically file the provisional patent application provided the receiving patent office accepts electronically filed provisional applications. In one embodiment, a user may enter the invention disclosure data in step 910, and then automatically execute steps 920-960 with a single mouse click, thereby drastically simplifying the process by which application filing dates are secured in a Patent Office.

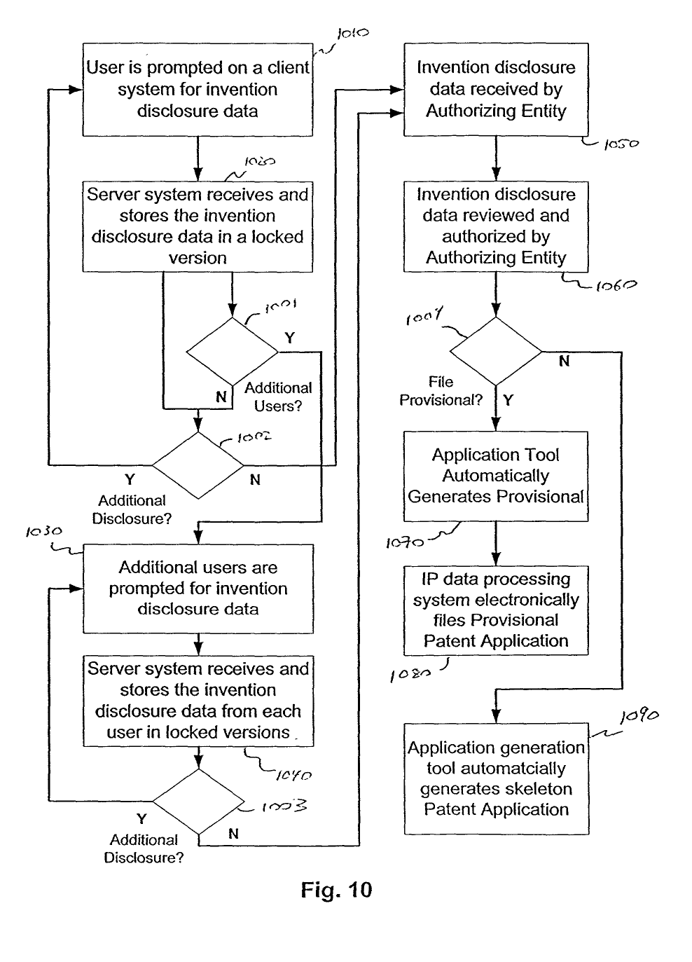

FIG. 10 illustrates a computer-implemented method of processing disclosure data according to another embodiment of the present invention. At step 1010 a user may be prompted on a client system for invention disclosure data. At step 1020, the server system may store the invention disclosure data in a locked version. In one embodiment, each version of all invention disclosures are stored in memory, date stamped, and links to each version are presented in a history tracking table as described in more detail below. After the invention disclosure data has been received, the system enters two decision steps 1001 and 1002. If a user desires to add additional invention disclosure data to an active Invention Disclosure at a later time, then steps 1010 and 1020 may be repeated. On the other hand, decision 1001 represents the determination of whether or not there are multiple users requiring access to the invention disclosure data. For example, if there are multiple inventors, then each inventor may add to or modify the invention disclosure data entered by other inventors. In one embodiment, multiple users from different technical and business disciplines (e.g., design, test, marketing, applications, management, research and development, intellectual property, etc.) are provided access to the invention disclosure data to supplement the invention disclosure data previously supplied by others. Accordingly, at step 1030 additional users may be prompted for invention disclosure data. At step 1040, the server system receives and stores the invention disclosure data from each user in locked versions. At decision step 1003, if additional disclosure is necessary then steps 1030 and 1040 may be repeated. However, if additional disclosure is not required at steps 1002 or 1003, then the invention disclosure data in each version may be forwarded to an authorization entity.

At step 1050, the invention disclosure is received by an authorization entity. An authorization entity may be, for example, a technical manager, business manager, intellectual property manager, in-house counsel, outside counsel, patent committee coordinator, or other individual or individuals charged with the responsibility of making the decision of whether or not to proceed with a patent. At step 1060, the invention disclosure data may be reviewed. At decision step 1004, the authorization entity may either authorize the filing of a provisional patent application or non-provisional patent application. Authorization at decision step 1004 may be carried out by transmitting a command signal, such as a single mouse click, from the authorization entity's client system to the server. When the command signal has a first value, a non-provisional may be filed, and when the command signal has a second value, a provisional may be filed. The command signal may be implemented using multiple electronic software buttons or a drop down menu, for example.

If a provisional application is desired, then, at step 1070, an application tool automatically generates a provisional patent application from the information disclosure data. For example, as previously discussed, the portions of the information disclosure data may be referred to as invention specification data elements. The application tool may extract the invention specification data elements and build a provisional application from a compilation of the invention specification data elements. The application tool may generate application tool results in the form of a document beginning with the title as extracted from the invention disclosure data. The application tool may format the resulting document such that the inventor's name, address, and other inventor data, as extracted from the invention disclosure data, appear with the title on a cover page. The invention specification data elements may then be written into the resulting file according to each section of a standard patent application as follows: Background of the Invention, Summary of the Invention, Brief Description of the Drawings, and Detailed Description. In other embodiments, a claims data element and abstract data element may be provided in the invention disclosure section and automatically written into a provisional or formal patent application by the application tool. Alternatively, as will be appreciated by those of skill in the art, the template can be set-up so that it prompts the user to add the claims and the abstract after it incorporates information from the Invention Disclosure. At step 1080, IP data processing system 100 may automatically file the provisional patent application electronically in an Official Patent Office.

If a provisional application is not desired at step 1004, then at step 1090, the application generation tool may automatically generate a skeleton patent application. A skeleton patent application may be used by in-house or outside counsel, or other patent practitioner, to prepare a formal patent application.

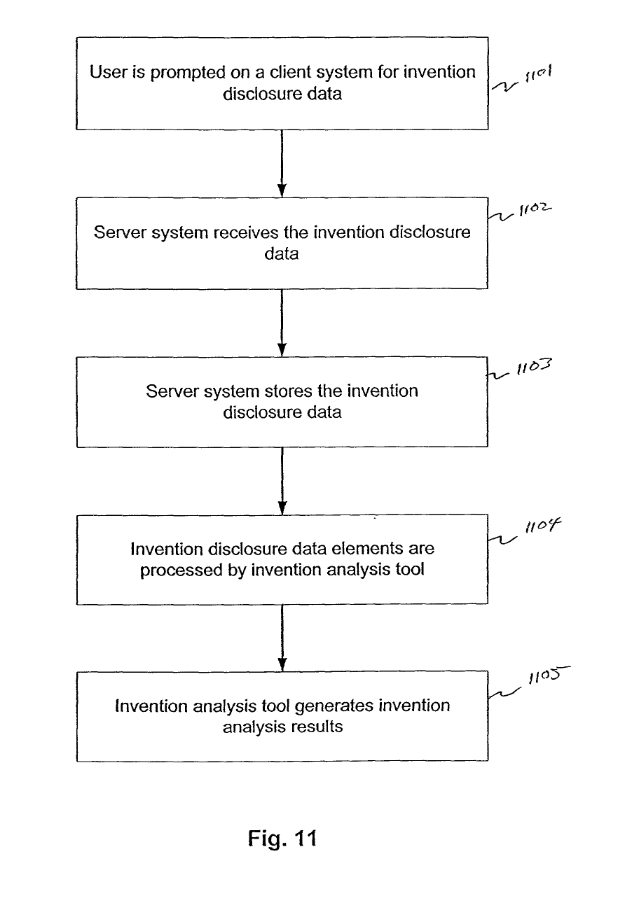

FIG. 11 illustrates a computer-implemented method of processing invention disclosure data according to another embodiment of the present invention. At step 1101, a user on a client system may be prompted for invention disclosure data. At step 1102, the server system receives the invention disclosure data. At step 1103, the server system stores the invention disclosure data. In one embodiment, the server system is an IP data processing system 100 of FIG. 7. At step 1104, invention disclosure data elements are processed by an invention analysis tool. In one embodiment, the invention disclosure data elements are invention specification data elements as describe above, and the corresponding invention analysis tool is the application generation tool for generating provisional or formal patent applications. In another embodiment, the invention analysis tool may be a publication generation tool for generating a defensive (or technical) publication from the invention specification data elements. Invention analysis tool could compare the invention to the prior art and identify overlap, or use the disclosure text to crawl the web for prior art. Alternatively, the invention analysis tool could use AI to suggest ways to expand the invention, e.g. alternatives, synonyms, applications in other fields, etc. In another embodiments, other portions of the invention disclosure data may be referred to as licensing data elements, case management data elements, docketing data elements, or information disclosure data elements for processing by a licensing tool, case management tool, docketing tool, or information disclosure tool, respectively. The data elements used as inputs to the corresponding analysis tools may be taken from the input fields illustrated in FIGS. 8A-8L, for example.

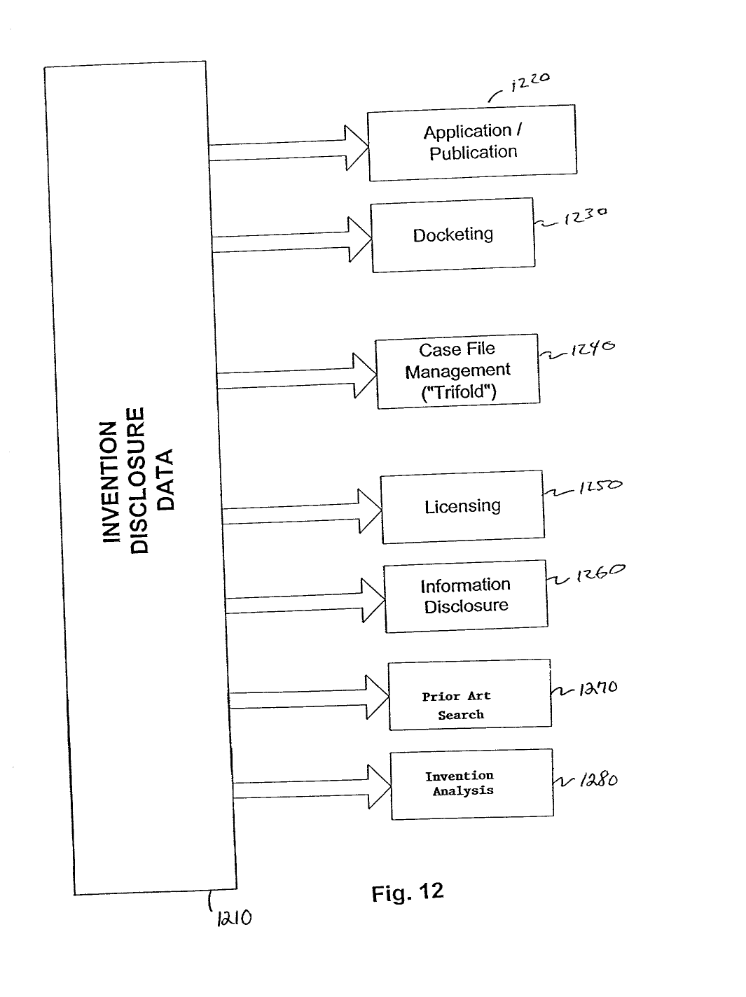

FIG. 12 illustrates how a plurality of different data fields of the invention disclosure data may be processed by a corresponding plurality of invention disclosure analysis tools according to one embodiment of the present invention. Different portions of invention disclosure data 1210 may be accessed and utilized for different purposes in the system. For example, as previously discussed, data fields that may be useful in a patent application or defensive publication may be processed by a application tool or publication tool 1220 to automatically generate patent applications or defensive publications from the invention disclosure data. Additionally, data fields of the invention disclosure data may be useful for docketing purposes. For example, data fields for Invention Publication field 834, Invention Disclosure field 835, and Confidentiality Agreement fields 836-843 may be processed by a docketing tool 1230 to automatically create bar dates and generate flags and reminders to different users of the system that such dates exist and are approaching. Additionally, Prototype field 845, Start Testing field 846, and Positive Test results field 847 may be automatically recorded by the docketing tool for establishing conception and reduction to practice, as well as signaling later prosecutors of the existence and date of any experimental uses that may have occurred. The present invention may also include a Case file management invention analysis tool 1240. The Case Management tool 1240 may access and process such data fields as the Title field 830 and one or more of the Inventor Information fields 820-829 to create a case management display for the user accessing a particular case. Additionally, a licensing tool 1250 may also be provided that may access and process such fields as the Project field 831, Product Name field 832, and Interested Companies field 833 to generate and track potential licensees for the patented technology. Moreover, an information disclosure tool 1260 may also be provided that may access and process the Search field 884 and Search Result field 885 from the Prior Art and Supporting Documents section 801. For example, when a user clicks the Submit Disclosure button 886, the information disclosure tool 1260 may be activated, to process the Search field 884 and Search Result field 885 to automatically generate an electronic IDS. It is to be understood that the invention disclosure data could contain additional information useful for any of these tools. Additionally, other invention analysis tools may be included in a system which prompts the user for invention disclosure data on a client, receives and stores the information on a server, and processes different data elements in the invention disclosure data using invention analysis tools to generate invention analysis results, without departing from the spirit and scope of the invention described here and claimed below.

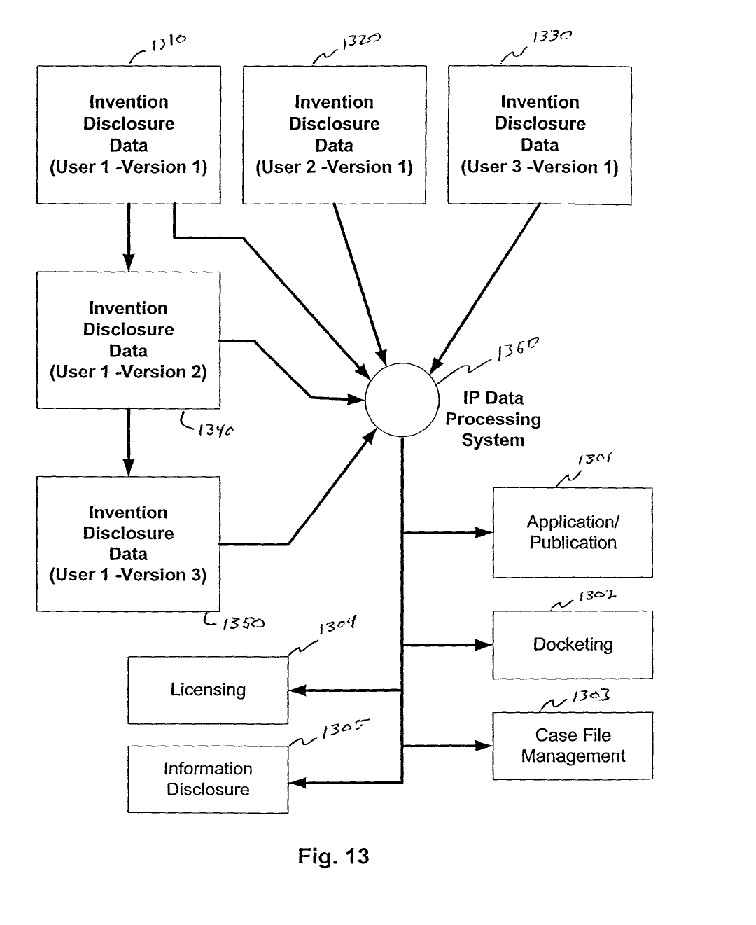

FIG. 13 illustrates how multiple invention disclosure data from disclosure of multiple users and from multiple versions of a single user's disclosure may be processed by invention disclosure analysis tools according to one embodiment of the present invention. As previously mentioned, a new invention disclosure may be created by a first user and invention disclosure data may be entered via the Invention Disclosure Data Wizard. FIG. 13 illustrates how multiple users may add invention disclosure data to an invention disclosure, how a each individual user may automatically create multiple versions of the invention disclosure data, and how the all the invention disclosure data related to a single invention disclosure may be automatically accessed and processed by a plurality of invention analysis tools. A new invention may be created, for example, by a first user (i.e., user 1). User 1 may enter some or all of the invention disclosure data 1310 to create and save a first version (i.e., version 1). User 1 may then use a messaging system to communicate to user 2 and user 3 that a new invention disclosure has been created. User 2 may access the invention disclosure on another client system and may review, supplement, or modify the data entered by user 1. User 2 may then create and save another version of the invention disclosure data 1320 (i.e., user 2-version 1). Likewise, user 3 may access the invention disclosure on yet another client system and may review, supplement, or modify the data entered by user 1 or 2, or both. User 3 may then create and save another version of the invention disclosure data 1330 (i.e., user 3-version 1).

User 1 may also create additional versions of the invention disclosure data. For example, additional version 1340 and 1350 may be created after user 1 reviews the invention disclosure data supplied by users 2 and 3. Additional versions may also be created after user 1 receives more information such as testing data, marketing data, or simulation data, for example. In one embodiment, each version of each user is time and date stamped for version control. The entries may then be presented in a history tracking table for different users to monitor the different versions. An exemplary history tracking table is illustrated in Table 1.

TABLE 1

| Created by | Creation Date/Time | Version | Comments |
|---|---|---|---|
| Inventor 1 | 03/01/2001 10:20 AM | 1.1 | Invention Background |
| | | | and Conception Date |
| Inventor 2 | 12/30/2001 04:30 PM | 2.1 | Testing Results |
| | | | and Description of |
| | | | Additional Embodiment. |
| | | | Searched USPTO and |
| | | | EPO database. |
| Inventor 3 | 06/14/2002 03:00 PM | 3.1 | Description of Best |
| | | | Mode of Making. |
| | | | Searched USPTO |
| | | | database. |
| Inventor 1 | 07/07/2002 09:30 AM | 1.2 | Review of Disclosures |
| | | | 1.1, 2.1, & 3.1. |
| | | | Additional Disclosure |
| | | | Added. |
| Inventor 1 | 07/07/2002 09:30 AM | 1.3 | Completed Descriptions. |
| | | | Sent to Patent Review |
| | | | Committee |
| Marketing | 07/07/2002 11:00 AM | 4.1 | Added Market Data and |
| | | | Potential Licensees |
| Applications | 07/07/2002 12:30 PM | 5.1 | Added Applications |
| | | | Data and Companies |
| | | | Potentially Interested |
| | | | in Invention |

Another particularly advantageous feature of the present invention is illustrated in FIG. 13. The information disclosure data entered by each user in each of the versions may automatically be accessed and processed by different invention analysis tools under the control of IP Data Processing System 100, which is illustrated at 1360 in FIG. 13. Accordingly, invention data elements in invention disclosure data 1310-1350 may be processed by Application Tool and Publication tool 1301, Docketing tool 1302, Case File Management tool 1303, Licensing tool 1304, and Information Disclosure tool 1305. When invention data elements from multiple invention disclosure data are accessed by an invention analysis tool, only non-overlapping information (i.e., data elements) in later created versions is processed by the particular tool. Accordingly, redundant information across later versions may be ignored, and supplemental information across later versions may be compiled by each tool to generate particular tool results (e.g., a provisional patent application or information disclosure statement).

It will be clear to those skilled in the art that improving the management of information according to the techniques here described will result in reduced filing times for patent applications, improved information to support the patent filing and investment decisions, improved patent specifications, improved patent prosecution management, and an increased ability of patentees to identify potential licensees to maximize the return on a patent investment. While specific embodiments and applications of the present invention have been illustrated and described, it is to be understood that the invention is not limited to the precise configuration and components disclosed herein and that various modifications, changes and variations which will be apparent to those skilled in the art may be made in the arrangement, operation, and details of the method and apparatus of the present invention disclosed herein without departing from the spirit and scope of the invention as defined in the following claims.

What is claimed is:

1. A computer-implemented method for securing intellectual property rights, the method comprising:
providing a smart electronic invention disclosure form to be filled out; and
receiving a filled-out invention disclosure in electronic form.

2. The method of claim 1 further comprising:
active prompting of an inventor by the smart disclosure form to provide best modes known to the inventor for practicing an invention.

3. The method of claim 2 further comprising:
active prompting of an inventor by the smart disclosure form to provide detailed information required to enable one of ordinary skill to practice the invention.

4. The method of claim 3 further comprising:
active prompting of an inventor by the smart disclosure form to identify co-inventors, if any, of the invention,
wherein the smart disclosure form prompts an inventor to input information in pre-selected fields.

5. The method of claim 4 further comprising:
receiving as input a single click of a button to cause the filled-out invention disclosure form to be converted in an automated way to a patent application,
wherein information in pre-selected fields of the invention disclosure form is selectively placed in a pre-selected location in said patent application.

6. The method of claim 5 wherein the single click also causes the patent application to be filed at a patent office.

7. The method of claim 6 wherein the patent application is filed at the patent office electronically.

8. The method of claim 7 further comprising:
executing the patent application with a digital signature of an inventor, assignee, or registered patent practitioner before the patent application is filed.

9. The method of claim 7 further comprising:
encrypting the patent application with a private key of the inventor, assignee, or registered patent practitioner before the provisional patent application is filed.

10. The method of claim 9 further comprising:
maintaining a registry of public keys at the patent office; and
decrypting the patent application with a public key for the inventor, assignee, or registered patent practitioner.

11. The method of claim 7 further comprising:
transmitting notification that the patent application was filed to an intellectual property (IP) server.

12. The method of claim 11 further comprising:
automatic calendaring by the IP server of a deadline date for foreign filing under an international convention.

13. The method of claim 12 further comprising:
transmitting a reminder communication from the IP server to a specified address at a specified time period before the deadline date.

14. The method of claim 12 wherein the patent application comprises a provisional patent application and further comprising:
automatic calendaring by the IP server of a deadline date for converting the provisional patent application to a non-provisional patent application.

15. The method of claim 4 further comprising:
providing drawing tool icons to facilitate creation of figures to be included in the filled-out invention disclosure.

16. The method of claim 15 further comprising:
active prompting of the inventor by the smart disclosure form to create figures depicting novel aspects of the invention.

17. The method of claim 4 further comprising:
receiving as input a single click on a scan button to cause a drawing to be scanned and included as a figure in the filled-out invention disclosure form.

18. A computer-implemented method of processing first invention disclosure data comprising:
prompting a user on a client system for first invention disclosure data;
receiving the first invention disclosure data from the client system on a server system, wherein the first invention disclosure data comprises a plurality of invention data elements;
storing the first invention disclosure data on the server system; and
processing each of the plurality of invention data elements using a corresponding plurality of invention analysis tools to produce a plurality of invention analysis results.

19. The method of claim 18 wherein the plurality of invention data elements include invention specification data elements.

20. The method of claim 19 wherein one of the invention analysis tools is an application generation tool, the method further comprising:
extracting the invention specification data elements from the invention disclosure data;
processing the invention specification data elements using the application generation tool; and
automatically generating a patent application.

21. The method of claim 19 wherein one of the invention analysis tools is an publication generation tool, the method further comprising:
extracting the invention specification data elements from the invention disclosure data;
processing the invention specification data elements using the publication generation tool; and
automatically generating a publication document.

22. The method of claim 18 wherein the plurality of invention data elements include licensing data elements.

23. The method of claim 22 wherein one of the invention analysis tools is an licensing analysis tool, the method further comprising:
extracting the licensing data elements from the invention disclosure data;
processing the licensing data elements using the licensing analysis tool; and
automatically generating licensing data results.

24. The method of claim 18 wherein the plurality of invention data elements include information disclosure data elements.

25. The method of claim 24 wherein one of the invention analysis tools is an information disclosure tool, the method further comprising:
extracting the information disclosure data elements from the invention disclosure data;
processing the information disclosure data elements using the information disclosure tool; and
automatically generating information disclosure results.

26. The method of claim 18 wherein the plurality of invention data elements include case management data elements.

27. The method of claim 26 wherein one of the invention analysis tools is an case management tool, the method further comprising:
extracting the case management data elements from the invention disclosure data;
processing the case management data elements using the case management tool; and
automatically generating case management results.

28. The method of claim 18 wherein the plurality of invention data elements include docketing data elements.

29. The method of claim 28 wherein one of the invention analysis tools is a docketing tool, the method further comprising:
extracting the docketing data elements from the invention disclosure data;
processing the docketing data elements using the docketing tool; and
automatically generating docketing results.

30. The method of claim 18 further comprising:
prompting a second user on a second client system for second invention disclosure data;
receiving the second invention disclosure data from the second client system on the server system, wherein the second invention disclosure data comprises a plurality of invention data elements;
storing the second invention disclosure data on the server system; and
processing each of the plurality of invention data elements from the first and second invention disclosure data using corresponding invention analysis tools to produce the plurality invention analysis results.

31. The method of claim 18 further comprising:
prompting the user for second invention disclosure data;
receiving the second invention disclosure data on the server system, wherein the second invention disclosure data comprises a plurality of invention data elements;
storing the second invention disclosure data with the first invention disclosure data in a disclosure history table on the server system; and
processing each of the plurality of invention data elements from the first and second invention disclosure data using corresponding invention analysis tools to produce the plurality invention analysis results,
wherein only non-overlapping information from the second invention disclosure data is processed by the analysis tools.

32. A server system comprising a processor and a computer-readable memory coupled to said processor, said computer-readable memory including computer instructions that:
(i) generate web pages to guide a client system through a process to create invention disclosure data;
(ii) store the invention disclosure data in a database; and
(iii) upon receipt of a command from a client system, automatically generate a provisional patent application from said invention disclosure data.

33. The server system of claim 32 wherein said computer instructions further electronically file the provisional patent application automatically in a patent office.

34. The server system of claim 32 wherein said computer instructions generate the provisional patent application when the command has a first value, and the computer instructions generate a non-provisional application when the command has a second value.

35. The server system of claim 32 wherein said computer instructions further docket a filing date.

36. The server system of claim 32 wherein said computer instructions further docket a bar date indicating the date by which a non-provisional must be filed.

37. The server system of claim 32 wherein said computer instructions further docket a foreign filing date deadline.
